(19) United States
(12) Patent Application Publication
(10) Pub. No.: US 2026/0251993 A1
(43) Pub. Date: Aug. 27, 2026

(54) TONER FOR DEVELOPING ELECTROSTATIC CHARGE IMAGE, METHOD FOR PRODUCING TONER FOR DEVELOPING ELECTROSTATIC CHARGE IMAGE, ELECTROSTATIC CHARGE IMAGE DEVELOPER, TONER CARTRIDGE, PROCESS CARTRIDGE, AND IMAGE FORMING APPARATUS

(71) Applicant: FUJIFILM Business Innovation Corp., Tokyo (JP)

(72) Inventors: Asafumi FUJITA, Kanagawa (JP); Tomoaki TANAKA, Kanagawa (JP); Kotaro YOSHIHARA, Kanagawa (JP); Tsuyoshi MURAKAMI, Kanagawa (JP)

(73) Assignee: FUJIFILM Business Innovation Corp., Tokyo (JP)

(21) Appl. No.: 19/311,869

(22) Filed: Aug. 27, 2025

(30) Foreign Application Priority Data
Feb. 27, 2025 (JP) 2025-030614

(51) Int. Cl. G03G 9/09; G03G 9/08; G03G 9/087

(52) U.S. Cl. CPC G03G 9/091; G03G 9/0808; G03G 9/0827; G03G 9/08755; G03G 2215/0604; G03G 2215/066; G03G 2221/183

(57) ABSTRACT

A toner for developing an electrostatic charge image includes a toner particle containing a binder resin and a pigment containing a fluorescent organic pigment, in which the amount of the pigment contained relative to the toner particle is 4.0 mass % or more and 20.0 mass % or less, the toner particle has a water absorption of 1.0% or less, at least part of the pigment is exposed in a surface of the toner particle, and 20% or more of the pigment exposed in the surface of the toner particle is covered with an oil.

### CROSS-REFERENCE TO RELATED APPLICATIONS

This application is based on and claims priority under 35 USC 119 from Japanese Patent Application No. 2025-030614 filed Feb. 27, 2025.

### BACKGROUND

### (i) Technical Field

The present disclosure relates to a toner for developing an electrostatic charge image, a method for producing a toner for developing an electrostatic charge image, an electrostatic charge image developer, a toner cartridge, a process cartridge, and an image forming apparatus.

### (ii) Related Art

Japanese Unexamined Patent Application Publication No. 2016-224339 discloses a toner for developing an electrostatic charge image, the toner containing toner particles and an external additive, in which the toner particles contain a binder resin containing a polyester resin, and a styrene (meth)acrylic resin forming domains having an average diameter of 300 nm or more and 800 nm or less in the toner particles, and the external additive contains oil-treated silica particles having a free oil amount of 3 mass % or more and 30 mass % or less.

### SUMMARY

Aspects of non-limiting embodiments of the present disclosure relate to a toner for developing an electrostatic charge image, the toner containing a toner particle containing a binder resin and a pigment containing a fluorescent organic pigment, in which the amount of the pigment contained relative to the toner particle is 4.0 mass % or more and 20.0 mass % or less, in which the toner suppresses fogging in the initial image that occurs when the image is formed at a high temperature and a high humidity after the toner is stored for a long time compared to when the toner particle has a water absorption exceeding 1.0% or when less than 20% of the pigment exposed in the surface of the toner particle is covered with an oil.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a toner for developing an electrostatic charge image, the toner including a toner particle containing a binder resin and a pigment containing a fluorescent organic pigment, in which an amount of the pigment contained relative to the toner particle is 4.0 mass % or more and 20.0 mass % or less, the toner particle has a water absorption of 1.0% or less, at least part of the pigment is exposed in a surface of the toner particle, and 20% or more of the pigment exposed in the surface of the toner particle is covered with an oil.

### BRIEF DESCRIPTION OF THE DRAWINGS

Exemplary embodiments of the present disclosure will be described in detail based on the following figures, wherein:

FIG. 1 is a diagram illustrating the state of a screw in one example of a screw extruder used in producing a toner for developing an electrostatic charge image according to the present disclosure;

FIG. 2 is a schematic diagram illustrating one example of an image forming apparatus according to an exemplary embodiment; and

FIG. 3 is a schematic diagram illustrating one example of a process cartridge detachably attached to an image forming apparatus according to an exemplary embodiment.

### DETAILED DESCRIPTION

Exemplary embodiments of the present disclosure will now be described. These descriptions and examples are relevant to the exemplary embodiments, and do not limit the scope of the exemplary embodiments.

In the present disclosure, any numerical range indicated by using “to” indicates a range that includes a figure that precedes “to” and a figure that follows “to” as the minimum value and the maximum value, respectively.

In the present disclosure, in a numerical range described stepwise, the upper limit or the lower limit of one numerical range may be replaced by the upper limit or the lower limit of a different numerical range also described stepwise. In addition, in any numerical range described in the present disclosure, the upper limit or the lower limit of the numerical range may be replaced by a value indicated in Examples.

In the present disclosure, the term “step” refers not only to an independent step but also to any feature that attains the intended purpose of the step although such a feature may not be clearly distinguishable from other steps.

In the present disclosure, when an exemplary embodiment is described with reference to a drawing, the structure of such an exemplary embodiment is not limited to the structure illustrated in the drawing. Furthermore, the dimensions of the members in each drawing are merely schematic, and the relative size relationships between the members are not limited to those illustrated in the drawing.

In the present disclosure, a component may contain more than one corresponding substances. When the amount of a component in a composition is mentioned in the present disclosure and when there are two or more substances that correspond to that component in the composition, the amount the component is the total amount of the two or more substances in the composition unless otherwise noted.

In the present disclosure, particles that correspond to a component may contain more than one types of particles. When there are two or more types of particles that correspond to a component in a composition, the particle size of the component means a value of a mixture of two or more types of particles present in the composition unless otherwise noted.

In the present disclosure, an alkyl group may be straight-chain, branched, or cyclic unless otherwise noted.

In the present disclosure, in an organic group, an aromatic ring, a linking group, an alkyl group, an aryl group, an aralkyl group, an alkoxy group, and an aryloxy group, a hydrogen atom may be substituted with a halogen atom.

### Toner for Developing Electrostatic Charge Image

A toner for developing an electrostatic charge image (hereinafter may also be referred to as a toner) according to an exemplary embodiment contains toner particles that contain a binder resin and a pigment containing a fluorescent organic pigment.

The amount of the pigment contained relative to the toner particles is 4.0 mass % or more and 20.0 mass % or less.

The toner particles has a water absorption of 1.0% or less.

At least part of the pigment is exposed in the surfaces of the toner particles, and 20% or more of the pigment exposed in the surfaces of the toner particles is covered with an oil.

The toner according to an exemplary embodiment serves as a toner for developing an electrostatic charge image in which fogging in the initial image, which occurs when an image is formed in a high-temperature, high-humidity environment after the toner has been stored for a long time, is suppressed. The reason for this is presumably as follows.

It is known that a toner that uses a pigment containing a fluorescent organic pigment (hereinafter may also be referred to as the “fluorescent toner”) is used to widen the color gamut of images.

Meanwhile, fluorescent toners are less frequently used compared to toners of other colors such as cyan toners, magenta toners, yellow toners, and black toners.

Thus, there is a tendency that a long time would elapse from the time the fluorescent toner is produced to the time the fluorescent toner is used, or from the time the fluorescent toner is used to the time the fluorescent toner is used next. In other words, fluorescent toners tend to be stored for a long time.

However, when a fluorescent toner is stored for a long time and then an image is formed at high temperature and high humidity, chargeability of the toner may be degraded due to moisture absorption, and fogging may occur in the initial image.

Specifically, when the amount of the pigment contained relative to the toner particles is set to 4.0 mass % or more and 20.0 mass % or less so that a large amount of the pigment is contained in the toner particles, the pigment easily becomes exposed from the toner particles. Since a pigment is a compound having crystals with low electrical resistance, the pigment exposed from the toner particles causes current leakage from the pigment exposed sites, and the chargeability of the toner is easily degraded. As a result, fogging in the initial images is likely to occur.

To address this, the water absorption of the toner particles in the toner of the exemplary embodiment is decreased to 1.0% or less. This suppresses degradation of the chargeability of the toner caused by moisture absorption.

In addition, the pigment exposed in the surfaces of the toner particles is covered with an oil, and the percentage at which this pigment is covered with the oil is set to 20% or more. As a result, the oil coating suppresses degradation of the chargeability of the toner caused by current leakage from the site where the pigment is exposed.

Presumably for the reasons described above, the toner according to this exemplary embodiment serves as a toner for developing an electrostatic charge image in which fogging in the initial image caused by forming an image at high temperature and high humidity after the toner is stored for a long time is suppressed.

The toner according to this exemplary embodiment will now be described in detail.

The toner according to the exemplary embodiment contains toner particles. The toner according to the exemplary embodiment may further contain an external additive.

### Toner Particles

The toner particles contain a binder resin and a pigment containing a fluorescent organic pigment. The toner particles may contain a releasing agent, internal additive resin particles, other additives, etc.

### Binder Resin

Examples of the binder resin include vinyl resins, for example, homopolymers obtained from monomers such as styrenes (for example, styrene, parachlorostyrene, and α-methylstyrene), (meth)acrylates (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (for example, acrylonitrile and methacrylonitrile), vinyl ethers (for example, vinyl methyl ether and vinyl isobutyl ether), vinyl ketones (for example, vinyl methyl ketone, vinyl ethyl ketone, and vinyl isopropenyl ketone), and olefins (for example, ethylene, propylene, and butadiene), and copolymers obtained from two or more of these monomers.

Other examples of the binder resin include non-vinyl resins such as epoxy resins, polyester resins, polyurethane resins, polyamide resins, cellulose resins, polyether resins, and modified rosin, mixtures of these non-vinyl resins and vinyl resins, and graft polymers obtained by polymerizing a vinyl monomer in the presence of these resins.

These binder resins may be used alone or in combination.

The binder resin may be a polyester resin.

An example of the polyester resin is a known polyester resin.

An example of the polyester resin is a polycondensation product between a polycarboxylic acid and a polyhydric alcohol.

Examples of the polycarboxylic acid include aliphatic dicarboxylic acids (for example, oxalic acid, malonic acid, maleic acid, fumaric acid, citraconic acid, itaconic acid, glutaconic acid, succinic acid, alkenylsuccinic acid, adipic acid, and sebacic acid), alicyclic dicarboxylic acids (for example, cyclohexane dicarboxylic acid), aromatic dicarboxylic acids (for example, terephthalic acid, isophthalic acid, orthophthalic acid, and naphthalenedicarboxylic acid), anhydrides thereof, and lower (for example, 1 to 5 carbon atoms) alkyl esters thereof. Among these, an aromatic dicarboxylic acid may be used as the polycarboxylic acid.

The polycarboxylic acid may be a combination of a dicarboxylic acid and a tri- or higher carboxylic acid having a crosslinked structure or a branched structure. Examples of the tri- or higher carboxylic acid include trimellitic acid, pyromellitic acid, anhydrides thereof, and lower (for example, 1 to 5 carbon atoms) alkyl esters thereof.

One polycarboxylic acid may be used alone, or two or more polycarboxylic acids may be used in combination.

Examples of the polyhydric alcohol include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, ethylene oxide adducts of bisphenol A and propylene oxide adducts of bisphenol A). Among these, for example, aromatic diols and alicyclic diols may be used as the polyhydric alcohol, and, in particular, an aromatic diol may be used as the polyhydric alcohol.

The polyhydric alcohol may be a combination of a diol and a tri- or higher polyhydric alcohol having a crosslinked structure or a branched structure. Examples of the tri- or higher polyhydric alcohol include glycerin, trimethylolpropane, and pentaerythritol.

Polyhydric alcohols may be used alone or in combination.

The glass transition temperature (Tg) of the polyester resin is preferably 50° C. or higher and 80° C. or lower and more preferably 50° C. or higher and 65° C. or lower.

The glass transition temperature is determined from a DSC curve obtained by differential scanning calorimetry (DSC), more specifically, according to “extrapolated glass transition onset temperature” described in the method for determining the glass transition temperature in JIS K 7121-1987 “Testing Methods for Transition Temperatures of Plastics”.

The weight-average molecular weight (Mw) of the polyester resin is preferably 5,000 or more and 1,000,000 or less and more preferably 7,000 or more and 500,000 or less.

The number-average molecular weight (Mn) of the polyester resin may be 2,000 or more and 100,000 or less.

The molecular weight distribution (Mw/Mn) of the polyester resin is preferably 1.5 or more and 100 or less and more preferably 2 or more and 60 or less.

The weight-average molecular weight and the number-average molecular weight are measured by gel permeation chromatography (GPC). The molecular weight measurement by GPC is conducted by using a GPC produced by TOSOH CORPORATION, HLC-8120GPC, as a measuring instrument with columns, TSKgel Super HM-M (15 cm) produced by TOSOH CORPORATION, and a THF solvent. The weight-average molecular weight and the number-average molecular weight are calculated from the measurement results by using the molecular weight calibration curves plotted from monodisperse polystyrene standard samples.

The polyester resin is obtained by a known production method. Specifically, for example, a polyester resin is obtained by a method that involves setting the polymerization temperature to 180° C. or higher and 230° C. or lower, reducing the pressure inside the reaction system as necessary, and performing the reaction while removing water and alcohol generated during condensation.

Here, when raw material monomers do not dissolve or mix at the reaction temperature, a solvent having a high boiling point may be added as a solubilizer to dissolve the monomers. In this case, the polycondensation reaction is carried out while distilling away the solubilizer. When there are monomers that are poorly miscible with each other, such monomers may be preliminarily condensed with an acid or an alcohol to be polycondensated with that monomer and then be subjected to polycondensation with other components.

It should be noted here that the polyester resin may be a hybrid resin that has a polyester resin pigment and a styrene-acryl copolymer segment.

The amount of the binder resin contained relative to the entire toner particles is preferably 40 mass % or more and 95 mass % or less, more preferably 50 mass % or more and 90 mass % or less, and yet more preferably 60 mass % or more and 90 mass % or less.

### Pigment

The pigment contains a fluorescent organic pigment. The pigment may contain a non-fluorescent organic pigment in addition to a fluorescent organic pigment.

A fluorescent organic pigment refers to an organic pigment that emits light by optical energy from the outside.

A non-fluorescent organic pigment refers to an organic pigment that does not emit light by optical energy from the outside.

In general, a fluorescent organic pigment develops color by reflected light and emitted light, and a non-fluorescent organic pigment develops color only by reflected light.

Here, the amount of the pigment contained relative to the toner particles is 4.0 mass % or more and 20.0 mass % or less, preferably 5.0 mass % or more and 18.0 mass % or less, and more preferably 6.0 mass % or more and 15.0 mass % or less.

When the amount of the pigment contained is 4.0 mass % or more, an image with an intended color (for example, an image having a sufficient fluorescent intensity) can be easily formed.

By setting the amount of the pigment contained to 20.0 mass % or less, insufficient dispersing of the pigment in the toner particles and generation of the large-sized pigment can be suppressed. Thus, an excessive increase in area of the pigment exposed in the toner particle surfaces is suppressed, and, thus, degradation of the toner chargeability and fogging in the initial image can be suppressed. Moreover, color streaks caused by development with a large-sized pigment can be suppressed.

### Fluorescent Organic Pigment

A fluorescent organic pigment may be of any color, for example, as long as the fluorescent organic pigment is an organic pigment that has fluorescence, and examples thereof include fluorescent yellow organic pigments, fluorescent pink organic pigments, fluorescent red organic pigments, fluorescent orange organic pigments, fluorescent green organic pigments, and fluorescent purple organic pigments.

Examples of the fluorescent organic pigment include azomethine compounds, isoindolinone compounds, xanthene compounds (including rhodamine compounds, fluorescein compounds, and eosin compounds), naphthalene compounds, and triarylmethane compounds.

Among these, azomethine compounds having an emission peak wavelength of 500 nm or more and 550 nm or less are preferable and bisazomethine compounds having an emission peak wavelength of 500 nm or more and 550 nm or less are more preferable as the fluorescent organic pigment. When these azomethine compounds are used, fluorescent yellow images with excellent fluorescent intensity can be formed.

Here, the emission peak wavelength is measured in accordance with the measurement method specified by Japanese Industrial Standards (JIS K 5101-3-3) by using, for example, UV-3600 (produced by Shimadzu Corporation, spectrophotometer).

An example of the azomethine compound is a compound having an azomethine structure represented by —R¹C═N— (where R¹ represents a hydrogen atom or a monovalent substituent).

An example of the bisazomethine compound is a compound intramolecularly having a bisazomethine structure represented by —R¹C═N—N═CR²— (where R¹ and R² each independently represent a hydrogen atom or a monovalent substituent).

The fluorescent organic pigment may have a hydrophilic group.

Examples of the hydrophilic group in the fluorescent organic pigment include a hydroxy group, primary to tertiary amino groups, a carboxy group, a sulfo group, and a phosphoric acid group.

In particular, the fluorescent organic pigment may contain a hydroxy group as the hydrophilic group.

Examples of the fluorescent organic pigment include the following azomethine compounds (1) to (3).

Azomethine fluorescent organic pigments

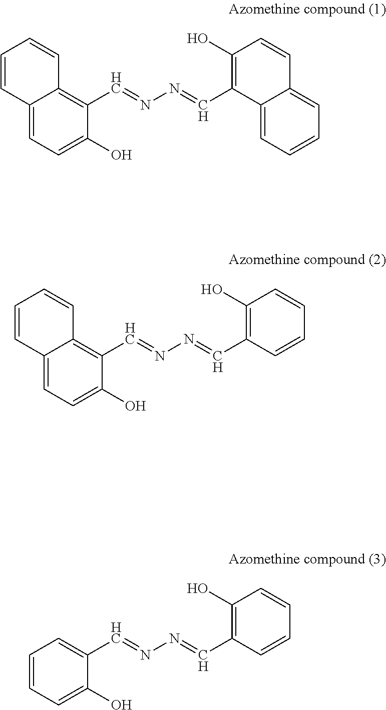 [SMILES: Oc1ccc2ccccc2c1/C=N/N=C/c1c(O)ccc2ccccc12 ; Oc1ccccc1/C=N/N=C/c1c(O)ccc2ccccc12 ; Oc1ccccc1/C=N/N=C/c1ccccc1O]

The emission peak wavelength of the azomethine compound (1) is 520 nm.

The emission peak wavelength of the azomethine compound (2) is 510 nm.

The emission peak wavelength of the azomethine compound (3) is 520 nm.

Other examples of the fluorescent organic pigment include derivatives of azomethine compounds, for example, a boron difluoride derivative of an azomethine compound.

Examples of the boron difluoride derivative of an azomethine compound are the following compounds.

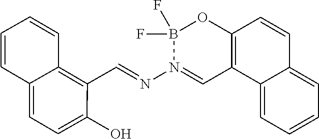

The fluorescent organic pigment may be at least one selected from the group consisting of the azomethine compound (1), the azomethine compound (2), the azomethine compound (3), and boron difluoride derivatives thereof.

The fluorescent organic pigment is preferably C.I. Pigment Yellow 101 or a boron difluoride derivative of C.I. Pigment Yellow 101 and is more preferably C.I. Pigment Yellow 101 represented by the azomethine compound (1).

The amount of the fluorescent organic pigment contained relative to the toner particles is preferably 3.0 mass % or more and 15.0 mass % or less, more preferably 4.0 mass % or more and 13.0 mass % or less, and yet more preferably 5.0 mass % or more and 10.0 mass % or less.

When the amount of the fluorescent organic pigment contained is 3.0 mass % or more, an image with a sufficient fluorescent intensity can be formed.

When the amount of the fluorescent organic pigment contained is 15.0 mass % or less, the pigment disperses easily in the toner, and thus the pigment is less likely to have a large particle size. Accordingly, the area of the pigment exposed in the toner particle surfaces rarely increases excessively. As a result, degradation of the toner chargeability is suppressed, and fogging in the initial image is less likely to occur. Moreover, color streaks caused by development with a large-sized pigment rarely occur.

### Non-Fluorescent Organic Pigment

The toner particles contain a non-fluorescent organic pigment.

A non-fluorescent organic pigment may be of any color, for example, as long as the non-fluorescent organic pigment is not fluorescent, and examples thereof include non-fluorescent green organic pigments, non-fluorescent red organic pigments, non-fluorescent yellow organic pigments, non-fluorescent pink organic pigments, non-fluorescent orange organic pigments, and non-fluorescent purple organic pigments.

In particular, a non-fluorescent organic pigment having a reflection peak wavelength of 480 nm or more and 540 nm or less (hereinafter may also be referred to as the “specific non-fluorescent organic pigment”) may be used.

In particular, when an azomethine compound having an emission peak wavelength of 500 nm or more and 550 nm or less is used in combination with the specific non-fluorescent organic pigment, a fluorescent green image having excellent fluorescent intensity can be formed.

Here, the reflection peak wavelength is measured by the same method as that for measuring the emission peak wavelength of the fluorescent organic pigment described above.

The specific non-fluorescent organic pigment may contain a halogen atom from the viewpoint of the reflectance.

Examples of the halogen atom in the specific non-fluorescent organic pigment include a fluorine atom, a chlorine atom, a bromine atom, and an iodine atom.

In particular, the specific non-fluorescent organic pigment preferably contains, as the halogen atom, at least one selected from the group consisting of a chlorine atom and a bromine atom from the viewpoint of the reflectance, more preferably contains a bromine atom, and particularly preferably contains a chlorine atom and a bromine atom.

The specific non-fluorescent organic pigment preferably contains 2 or more halogen atoms from the viewpoint of the reflectance, more preferably contains 4 or more halogen atoms, yet more preferably contains 6 or more halogen atoms, and particularly preferably contains 8 or more and 32 or less halogen atoms.

Examples of the specific non-fluorescent organic pigment include lake pigments of halogenated phthalocyanine compounds and halogenated triphenylmethane dyes.

The specific non-fluorescent organic pigment is preferably a halogenated phthalocyanine compound, is preferably at least one selected from the group consisting of halogenated copper phthalocyanine and halogenated zinc phthalocyanine, and is more preferably halogenated copper phthalocyanine.

Examples of the halogenated copper phthalocyanine include C.I. Pigment Green 7 (specific gravity: 2.1, reflection peak wavelength: 500 nm, containing 16 chlorine atoms) and C.I. Pigment Green 36 (specific gravity: 2.9, reflection peak wavelength: 510 nm, containing 10 chlorine atoms and 6 bromine atoms).

The amount of the non-fluorescent organic pigment contained relative to the toner particles is selected according to the florescent color of the intended fluorescent image and is preferably 1.0 mass % or more and 17.0 mass % or less, more preferably 1.5 mass % or more and 12.0 mass % or less, and yet more preferably 2.0 mass % or more and 8.0 mass % or less.

### Releasing Agent

Examples of the releasing agent include hydrocarbon wax; natural wax such as carnauba wax, rice wax, and candelilla wax; synthetic or mineral or petroleum wax such as montan wax; and ester wax such as fatty acid esters and montanic acid esters. The releasing agent is not limited to these.

The melting temperature of the releasing agent is preferably 50° C. or higher and 110° C. or lower and more preferably 60° C. or higher and 100° C. or lower.

The melting temperature is determined from a DSC curve obtained by differential scanning calorimetry (DSC) according to “Melting peak temperature” described in the method for determining the melting point in JIS K 7121-1987 “Testing Methods for Transition Temperatures of Plastics”.

The amount of the releasing agent contained relative to the entire toner particles is preferably 1 mass % or more and 20 mass % or less and more preferably 4 mass % or more and 15 mass % or less.

### Internal Additive Resin Particles

Examples of the internal additive resin particles include polyolefin resins (polyethylene, polypropylene, etc.), styrene resins (polystyrene, α-polymethylstyrene, etc.), (meth)acrylic resins (polymethyl methacrylate, polyacrylonitrile, etc.), epoxy resins, polyurethane resins, polyurea resins, polyamide resins, polycarbonate resins, polyether resins, polyester resins, and copolymer resins of these.

The internal additive resin particles may be styrene-(meth)acrylic copolymer resin particles.

An example of the styrene-(meth)acrylic copolymer resin particles is resin particles obtained by radical polymerization between a styrene monomer and a (meth)acrylic acid monomer.

Examples of the styrene monomer include styrene, α-methylstyrene, vinylnaphthalene, alkyl-substituted styrenes having alkyl chains such as 2-methylstyrene, 3-methylstyrene, 4-methylstyrene, 2-ethylstyrene, 3-ethylstyrene, and 4-ethylstyrene, halogen-substituted styrenes such as 2-chlorostyrene, 3-chlorostyrene, and 4-chlorostyrene, and fluorine-substituted styrenes such as 4-fluorostyrene and 2,5-difluorostyrene. Among these, styrene and α-methylstyrene are preferable as the styrene monomer.

Examples of the (meth)acrylic acid monomer include (meth)acrylic acid, n-methyl (meth)acrylate, n-ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, phenyl (meth)acrylate, biphenyl (meth)acrylate, diphenylethyl (meth)acrylate, t-butylphenyl (meth)acrylate, terphenyl (meth)acrylate, cyclohexyl (meth)acrylate, t-butylcyclohexyl (meth)acrylate, dimethylaminoethyl (meth)acrylate, diethylaminoethyl (meth)acrylate, methoxyethyl (meth)acrylate, 2-hydroxyethyl (meth)acrylate, β-carboxyethyl (meth)acrylate, (meth)acrylonitrile, and (meth)acrylamide. Among these, n-butyl (meth)acrylate and β-carboxyethyl (meth)acrylate are preferable as the (meth)acrylic acid monomer.

The internal additive resin particles may be crosslinked resin particles. Examples of the crosslinking agent for crosslinking the resin in the crosslinked resin particles include aromatic polyvinyl compounds such as divinylbenzene and divinylnaphthalene; polyvinyl esters of aromatic polycarboxylic acids such as divinyl phthalate, divinyl isophthalate, divinyl terephthalate, divinyl homophthalate, divinyl trimesate, trivinyl trimesate, di vinyl naphthalene dicarboxylate, and divinyl biphenylcarboxylate; divinyl esters of nitrogen-containing aromatic compounds such as divinyl pyridinedicarboxylate; vinyl esters of unsaturated heterocyclic carboxylic acids such as vinyl pyromucate, vinylfuran carboxylate, vinylpyrrole-2-carboxylate, and vinylthiophene carboxylate; (meth)acrylic acid esters of straight-chain polyhydric alcohols such as butanediol methacrylate, hexanediol acrylate, hexanediol dimethacrylate, octanediol diacrylate, octanediol methacrylate, nonanediol diacrylate, nonanediol dimethacrylate, decanediol acrylate, decanediol dimethacrylate, dodecanediol diacrylate, and dodecanediol methacrylate; (meth)acrylic acid esters of branched and substituted polyhydric alcohols such as neopentyl glycol dimethacrylate and 2-hydroxy-1,3-diacryloxypropane; and polyethylene glycol di(meth)acrylates and polypropylene polyethylene glycol di(meth)acrylates. These crosslinking agents may be used alone or in combination.

An example of the copolymerized resin particles of a styrene monomer and a (meth)acrylic acid monomer is copolymer resin particles obtained by using styrene as the styrene monomer and butyl n-acrylate as the (meth)acrylic acid monomer at a mass ratio of the styrene monomer to the (meth)acrylic acid monomer (styrene monomer/(meth)acrylic acid monomer) of 70/30 or more and 10/90 or less (preferably 65/35 or more and 20/80 or less).

When the crosslinked resin particles use a crosslinking agent, the crosslinking agent may be a difunctional alkyl acrylate having an alkylene chain having 6 or more and 12 or less carbon atoms. The amount of the crosslinking agent contained relative to a total of 100 parts by mass of the styrene monomer, the (meth)acrylic acid monomer, and the crosslinking agent is preferably 0.3 parts by mass or more and 5.0 parts by mass or less, more preferably 0.5 parts by mass or more and 2.5 parts by mass or less, and yet more preferably 1.0 parts by mass or more and 2.0 parts by mass or less.

The average primary particle size of the internal additive resin particles is preferably 50 nm or more and 500 nm or less, more preferably 20 nm or more and 300 nm or less, and yet more preferably 30 nm or more and 250 nm or less.

When the average primary particle size of the internal additive resin particles is within the aforementioned range, the particles do not easily aggregate in the toner particles and tend to exist in an appropriate size.

The average primary particle size of the internal additive resin particles is measured by using a transmission electron microscope (TEM).

For example, JEM-2100 plus produced by JEOL Ltd., can be used as the transmission electron microscope.

Specifically, the average primary particle size of the internal additive resin particles is measured as follows.

First, a toner particle is sliced with a microtome into a thickness of about 0.1 μm. The section of the toner particle is photographed with a transmission electron microscope at a magnification of 10,000×, the equivalent circle diameter of each of one hundred internal additive resin particles dispersed in the toner particle is calculated from the cross-sectional area thereof, and the results are arithmetically averaged to obtain an average primary particle size.

The amount of the internal additive resin particles contained relative to the toner particles is preferably 2 mass % or more and 30 mass % or less, more preferably 3 mass % or more and 25 mass % or less, and yet more preferably 5 mass % or more and 20 mass % or less.

### Other Additives

Examples of other additives include known additives such as magnetic bodies, charge controllers, and inorganic powders. These additives are contained as internal additives in the toner particles.

### Properties of Toner Particles, Etc.

### Water Absorption of Toner Particles

The water absorption of the toner particles is 1.0% or less, more preferably 0.9% or less, and yet more preferably 0.8% or less.

When the water absorption of the toner particles is 1.0% or less, progress of the toner particles absorbing the water during long-term storage of the toner can be suppressed. As a result, degradation of chargeability and occurrence of fogging in the initial image can be suppressed.

An example of the method for adjusting the water absorption of the toner particles to be within the aforementioned range is a method that involves decreasing the amount of the surfactant contained in the toner particles.

Specifically, the amount of the surfactant contained relative to the toner particles is preferably 0 mass % or more and 1.0 mass % or less and more preferably 0 mass % or more and 0.8 mass % or less. In other words, the surfactant is not to be contained in the toner particles, or, if contained, the amount thereof is preferably 1.0 mass % or less and more preferably 0.8 mass % or less.

Here, the surfactant is a compound that has a hydrophilic group and a hydrophobic group in one molecule. The surfactant corresponds to any known surfactant such as an anionic surfactant, a cationic surfactant, an ampholytic surfactant, or a nonionic surfactant.

The water absorption of the toner particles is calculated by the following method.

Toner particles (or toner) to be measured are immersed in boiling hot water for 1 hour, and then the mass W1 of the toner particles (or toner) that have absorbed water is measured. Next, the toner particles (or toner) that have absorbed water is dried at 120° C. for 2 hours, and then the mass W2 of the dried toner particles (or toner) is measured. Next, the water absorption of the toner particles (or toner) is calculated from the equation below.

$$Water absorption ( mass \% ) = ( W 1 - W 2 ) / W 2 \times 100$$

Covering the Pigment with Oil

In the toner according to the present exemplary embodiment, at least part of the pigment is exposed in the surfaces of the toner particles, and the pigment exposed in the surfaces of the toner particles is covered with an oil.

The percentage at which the pigment exposed in the surfaces of the toner particles is covered with an oil (hereinafter this percentage may be referred to as the “oil coverage”) is 20% or more, preferably 25% or more, and yet more preferably 30% or more.

When the oil coverage is 20% or more, current leakage from the pigment exposed from the toner particles is reduced. As a result, degradation of chargeability of the toner and occurrence of fogging in the initial image can be easily suppressed.

From the viewpoint of contamination inside the developing machine, the oil coverage is preferably 60% or less and more preferably 50% or less.

The method for measuring the oil coverage (the percentage at which the exposed pigment is covered with the oil) is as follows.

A surfactant aqueous solution containing 0.5 mass % of a surfactant (NOIGEN ET-165 produced by DKS Co. Ltd.) in ion exchange water is prepared. Into a 100 mL glass beaker, 50 mL of the surfactant aqueous solution is placed, 4 g of a green toner is added thereto, and the resulting mixture is stirred for 5 minutes at a rotation rate of 100 rpm with a magnetic stirrer to prepare a toner dispersion. Two such toner dispersions are prepared.

A probe of an ultrasonic homogenizer (VCX750 produced by Sonics & Materials, Inc.) is inserted to one of the toner dispersions (the probe is inserted such that the distance between the tip of the probe and the bottom of the beaker is 1.0 cm), and ultrasonic waves at an output of 20 W and a frequency of 20 kHz are applied for 1 minute. The toner dispersion is centrifuged and fractionated according to the density into green toner particles, oil-treated silica particles, and other external additives, and the fraction containing the oil-treated silica particles is recovered. The fraction is dried, and a sample is taken from the toner to be measured.

The taken sample is observed with a scanning electron microscope (SEM-EDX) equipped with an energy dispersive X-ray fluorescence analyzer so that one toner particle is observed with a magnification of 10,000×.

Next, an element map of one toner particle surface is prepared by the energy dispersive X-ray fluorescence analyzer. In the element map of the one toner particle surface, the area of a region occupied by the elements derived from the pigment is assumed to be A, the area of a region occupied by the elements derived from the oil on the region occupied by the elements derived from the pigment is assumed to be B, and the oil coverage is calculated from the equation: oil coverage=B/A×100. This operation is performed on 100 toner particles, and the arithmetic average of the oil coverage is determined.

Here, the elements derived from the pigment correspond to, for example, nitrogen when the fluorescent organic pigment is an azomethine compound, and a halogen when the non-fluorescent organic pigment is a halogenated phthalocyanine compound. In other words, when an azomethine compound and a halogenated phthalocyanine compound are used as the pigment, the region occupied by nitrogen and halogen atoms as the elements derived from the pigment is assumed to be the area A.

Meanwhile, the elements derived from the oil correspond to silicon (Si) when the oil is a silicone oil, for example. In other words, when a silicone oil is used as the oil, a region occupied by silicon (Si) as the element derived from the oil is assumed to be the area B.

The observation conditions for the scanning electron microscope are an acceleration voltage of 15 kV, an emission current of 20 μA, and a working distance (WD) of 15 mm.

The analysis conditions by the energy dispersive X-ray fluorescence analyzer are the same as the observation conditions for the scanning electron microscope, and the detection time is 60 minutes.

The oil covering the pigment is, for example, at least one compound selected from the group consisting of lubricating oils, and oils and fats. Specific examples of the oil include a silicone oil, a paraffin oil, a fluorine oil, a mineral oil, and a vegetable oil. These oils may be used alone or in combination.

Examples of the silicone oil include dimethyl silicone oil, methylphenyl silicone oil, chlorophenyl silicone oil, methylhydrogen silicone oil, alkyl-modified silicone oil, fluorine-modified silicone oil, polyether-modified silicone oil, alcohol-modified silicone oil, amino-modified silicone oil, epoxy-modified silicone oil, epoxy-polyether-modified silicone oil, phenol-modified silicone oil, carboxyl-modified silicone oil, mercapto-modified silicone oil, acryl- or methacryl-modified silicone oil, and α-methylstyrene-modified silicone oil.

An example of the paraffin oil is liquid paraffin.

Examples of the fluorine oil include fluorine oil and fluorochloridone oil.

An example of the mineral oil is machine oil.

Examples of the vegetable oil include rapeseed oil and palm oil.

Of these oils, a silicone oil may be used from the viewpoint of suppressing current leakage from the pigment exposed from the toner particles and suppressing fogging in the initial image.

### Percentage of Area Occupied by Pigment Exposed in Toner Particle Surfaces

The percentage of the area occupied by the pigment exposed in the toner particle surfaces relative to the total area of the toner particle surfaces when the toner particle surfaces are observed is preferably 10 area % or more and 50 area % or less, more preferably 15 area % or more and 45 area % or less, and yet more preferably 20 area % or more and 40 area % or less.

Even when the percentage of the area occupied by the pigment exposed in the toner particle surfaces is 50 area % or more, as long as the pigment exposed in the toner particle surfaces is covered with the oil at the aforementioned oil coverage, fogging in the initial image is suppressed.

When the percentage of the area occupied by the pigment exposed in the toner particle surfaces is 10 area % or less, the pigment does not become excessively exposed, and degradation of chargeability is easily suppressed. As a result, fogging in the initial image is easily suppressed.

The percentage of area occupied by the pigment exposed in toner particle surfaces is measured as with the measurement of the oil coverage, that is, the area A of the region occupied by the elements derived from the pigment in one toner particle is calculated. Then the area C of the toner particle observed and the area A of the region occupied by the elements derived from the pigment are substituted into the equation: percentage of area occupied by pigment=A/C×100 to calculate the percentage of the area occupied by the pigment. This operation is performed on 100 toner particles, and the arithmetic average of the percentage of the area occupied by the pigment is determined.

### Average Circularity of Toner Particles

The average circularity of the toner particles is preferably less than 0.940, more preferably 0.900 or more and 0.938 or less, and yet more preferably 0.910 or more and 0.935 or less.

Even when non-spherical toner particles having an average circularity of less than 0.940 are used, fogging in the initial image caused by forming an image at high temperature and high humidity after the toner is stored for a long time is suppressed.

The average circularity of the toner particles is determined from (equivalent circle perimeter)/(perimeter) [(perimeter of a circle having the same projection area as the particle image)/(perimeter of a particle projection image)]. A specific measurement method is as follows.

First, toner particles to be measured are sampled by suction, are allowed to form a flat flow, and are imaged to obtain still images by instantaneous strobe light emission, and these particle images are analyzed by a flow-type particle image analyzer (Parshe Analyzer PAS produced by Hosokawa Micron Corporation). In determining the average circularity, 10,000 particles are sampled.

When the toner contains an external additive, the toner (developer) to be measured is dispersed in surfactant-containing water, and then ultrasonically treated to obtain toner particles from which the external additive has been removed.

### Volume-Average Particle Size of Toner Particles

The volume-average particle size (D50v) of the toner particles is preferably 2 μm or more and 10 μm or less and more preferably 4 μm or more and 8 μm or less.

Various average particle sizes and various particle size distribution indices of the toner particles are measured by using COULTER MULTISIZER II (produced by Beckman Coulter Inc.) and ISOTON-II (produced by Beckman Coulter Inc.) as the electrolyte.

In measuring, a 0.5 mg or more and 50 mg or less of a measurement sample is added to 2 mL of a 5% aqueous solution of a surfactant (for example, sodium alkylbenzene sulfonate) serving as a dispersing agent. The resulting mixture is added to 100 mL or more and 150 mL or less of the electrolyte.

The electrolyte solution containing the suspended sample is dispersed for 1 minute with an ultrasonic dispersing machine, and the particle size distribution of particles having a particle size in the range of 2 μm or more and 60 μm or less is measured by using COULTER MULTISIZER II with an aperture having a diameter of 100 μm. The number of sampled particles is 50,000.

On the basis of the measured particle size distribution, the volume and the number are plotted versus divided particle size ranges (channels) from the small diameter side to draw cumulative distributions, and then the particle sizes at 16% accumulation are defined as a volume particle size D16v and a number particle size D16p, the particle sizes at 50% accumulation are defined as a volume average particle size D50v and accumulated number average particle size D50p, and the particle sizes at 84% accumulation are defined as a volume particle size D84v and a number particle size D84p.

Then the volume particle size distribution index (GSDv) and the number particle distribution index (GSDp) are calculated as (D84v/D16v)^{1/2} and (D84p/D16p)^{1/2}, respectively, from these values.

### External Additive

An example of the external additive is inorganic particles. Examples of the inorganic particles include SiO₂, TiO₂, Al₂O₃, SrTiO₃, CaTiO₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

Other examples of the external additive include resin particles (resin particles of polystyrene, polymethyl methacrylate (PMMA), melamine resin, etc.), and cleaning lubricating agents (for example, particles higher fatty acid metal salts such as zinc stearate, and higher alcohols).

In particular, the external additive may be silica particles treated with an oil (oil-treated silica particles). When the oil-treated silica particles are used, the oil coverage for the pigment exposed from the toner particles can be easily controlled to be within the aforementioned range.

The oil-treated silica particles are silica particles surface-treated with an oil.

The silica particles subjected to the oil treatment are silica, that is, particles containing SiO₂ as a component, and may be crystalline or amorphous. The silica particles may be particles produced by using a silicon compound, such as liquid glass or alkoxysilane, as a raw material, or may be particles obtained by grinding quartz.

Specific examples of the silica particles include sol-gel silica particles, aqueous colloidal silica particles, alcoholic silica particles, fumed silica particles obtained by a gas phase method, and fused silica particles.

Examples of the oil with which the silica particles are surface-treated include the same oils as those oils that cover the pigment exposed from the toner particles.

The amount of the oil-treated silica particles contained relative to the toner particles may be 0.5 mass % or more and 5.0 mass % or less. The amount is preferably 0.7 mass % or more and 4.5 mass % or less and more preferably 0.8 mass % or more and 4.0 mass % or less.

When the amount of the oil-treated silica particles contained is 0.5 mass % or more and 5.0 mass % or less, the oil coverage for the pigment exposed from the toner particles can be easily controlled to be within the aforementioned range. As a result, fogging in the initial image is easily reduced.

### Amount of Free Oil

The amount of the free oil in the oil-treated silica particles is preferably 5.0 mass % or more and 30.0 mass % or less, more preferably 8.0 mass % or more and 28.0 mass % or less, and yet more preferably 10.0 mass % or more and 25.0 mass % or less.

When the amount of the free oil in the oil-treated silica particles is 5.0 mass % or more, the free oil transitions onto the pigment exposed from the toner particles, and the oil coverage for the pigment is easily controlled to be within the aforementioned range. As a result, the fogging in the initial image is easily reduced.

When the amount of free oil in the oil-treated silica particles is 30.0 mass % or less, adhesion of the excessive free oil onto the pigment-nonexposed sites of the toner particles or the members constituting the image forming apparatus is suppressed. As a result, occurrence of toner aggregates and occurrence of color streaks are suppressed.

The amount of free oil is the percentage of the free oil relative to all oil-treated silica particles. The amount of free oil is a value measured by the following method.

The oil-treated silica particles are subjected to proton nuclear magnetic resonance (NMR) analysis with AL-400 (magnetic field: 9.4 T (H nucleus, 400 MHz)) produced by JEOL LTD.

A sample, a deuterated chloroform solvent, and TMS as a standard substance are charged in a zirconia sample tube (diameter: 5 mm). The resulting sample tube is set and measured at a frequency of 487 kHz/400 MHz (=420 ppm), a measurement temperature of 25° C., number of runs: 16, and a resolution of 0.24 Hz (32,000 points), and the peak intensity derived from the free oil is converted into the amount of free oil by using a calibration curve.

For example, when dimethyl silicone oil is used as the oil, untreated silica particles and dimethyl silicone oil (varying the amount by about five levels) are subjected to NMR measurement to prepare a calibration curve of the amount of free oil and the NMR peak intensity. Then the calibration curve is used to calculate the amount of free oil.

To increase the amount of free oil in the oil-treated silica particles, for example, the oil treatment is performed multiple times. To decrease the amount of free oil in the oil-treated silica particles, for example, a step of dipping the particles in a solvent and drying the resulting particles is repeated.

### Volume-Average Particle Size

The volume-average particle size of the oil-treated silica particles is preferably 15.0 nm or more and 200 nm or less, more preferably 40 nm or more and 150 nm or less, and yet more preferably 80 nm or more and 120 nm or less.

When the volume-average particle size of the oil-treated silica particles is 15.0 nm or more, the oil-treated silica particles easily come into contact with the pigment exposed from the toner particles, and the oil coverage for the pigment is easily controlled to be within the aforementioned range. As a result, the fogging in the initial image is easily reduced.

When the volume-average particle size of the oil-treated silica particles is 200 nm or less, transition of the oil-treated silica particles onto members constituting the image forming apparatus and adhesion of the excessive free oil onto the members constituting the image forming apparatus are suppressed. As a result, occurrence of toner aggregates and occurrence of color streaks are suppressed.

The volume-average particle size of the oil-treated silica particles is a value measured by the following method.

One hundred primary particles of the oil-treated silica particles are observed with a scanning electron microscope (SEM). Next, the longest diameter and the shortest diameter are measured for each of the particles by image analysis of the primary particles, and an equivalent spherical diameter is determined from the intermediate value thereof. The 50% diameter (D50v) in the volume-based cumulative frequency of the obtained equivalent spherical diameters is assumed to be the volume-average particle size of the oil-treated silica particles.

### Toner Production Method

A toner according to an exemplary embodiment is obtained by externally adding an external additive to the toner particles after production of the toner particles.

The toner particles may be produced by a dry method (for example, a kneading and pulverizing method) or a wet method (for example, an aggregation and coalescence method, a suspension polymerization method, or a dissolution and suspension method). No limits are imposed on these production methods, and any known method may be employed. Among these methods, the kneading and pulverizing method may be used to obtain toner particles.

The kneaded and pulverized toner particles obtained by the kneading and pulverizing method contain less surfactant, and the water absorption of the toner can be decreased to the aforementioned range. Meanwhile, in the kneaded and pulverized toner particles, the amount of the pigment exposed is large; however, since the exposed pigment is covered with the oil at the aforementioned oil coverage, fogging of the initial image is suppressed even with the kneaded and pulverized toner particles.

### Kneading and Pulverizing Method

When toner particles are to be produced by a kneading and pulverizing method, the following production method may be employed.

The production method includes a kneading step of kneading a binder resin and a pigment containing a fluorescent organic pigment to obtain a kneaded material, and a pulverizing step of pulverizing the obtained kneaded material to obtain toner particles.

If necessary, other steps such as a cooling step of cooling the kneaded material prepared in the kneading step may be included.

The respective steps will now be described in detail.

### Kneading Step

In the kneading step, a material (hereinafter may also be referred to as a toner particle-forming material) that contains a binder resin, a pigment, and, if necessary, additives is kneaded.

In the kneading step, 0.5 parts by mass or more and 5 parts by mass or less of an aqueous medium (for example, water such as distilled water and ion exchange water, and alcohols) may be added to 100 parts by mass of the toner particle-forming material.

A kneading machine used in the kneading step is, for example, a single-screw extruder or a twin-screw extruder. In the description below, a kneading machine equipped with feed screw units and two kneading units is described with reference to the drawing as one example of the kneading machine; however, the kneading machine is not limited to this.

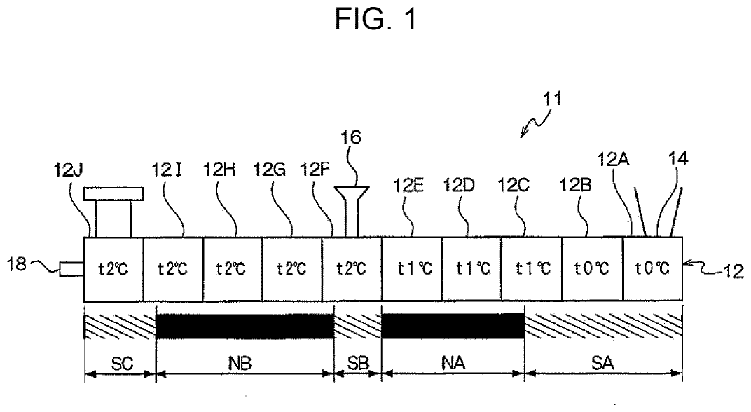

FIG. 1 is a diagram illustrating the state of a screw in one example of a screw extruder used in the kneading step of a toner production method of this exemplary embodiment.

A screw extruder 11 is constituted by a barrel 12 equipped with a screw (not illustrated), an injection port 14 through which a toner particle-forming material serving as a material of the toner is injected to the barrel 12, a liquid addition port 16 through which an aqueous medium is added to the toner particle-forming material in the barrel 12, and a discharge port 18 through which a kneaded material formed by mixing the toner particle-forming material in the barrel 12 is discharged.

The barrel 12 is divided into, in order of proximity to the injection port 14, a feed screw unit SA that conveys the toner particle-forming material injected through the injection port 14 to a kneading unit NA, a kneading unit NA for melt-kneading the toner particle-forming material in the first kneading step, a feed screw unit SB that conveys the toner particle-forming material melt-kneaded in the kneading unit NA to a kneading unit NB, a kneading unit NB in which the toner particle-forming material is melt-kneaded in a second kneading step to prepare a kneaded material, and a feed screw unit SC that conveys the resulting kneaded material to the discharge port 18.

In addition, temperature controllers (not illustrated) that differ from one block to another are installed in the barrel 12. In other words, blocks 12A to 12J may be controlled at different temperatures. It should be noted that FIG. 1 illustrates a state where the temperatures of the blocks 12A and 12B are controlled to t0° C., the temperatures of the blocks 12C to 12E are controlled to t1° C., and the temperatures of the blocks 12F to 12J are controlled to t2° C. In this manner, the toner particle-forming material in the kneading unit NA is heated to t1° C., and the toner particle-forming material in the kneading unit NB is heated to t2° C.

When the toner particle-forming material is supplied from the injection port 14 to the barrel 12, the toner particle-forming material is fed to the kneading unit NA by the feed screw unit SA. Here, since the temperature of the block 12C is set to t1° C., the toner particle-forming material heated into a molten state is fed to the kneading unit NA. Since the temperatures of the blocks 12D and 12E are also set to t1° C., the toner particle-forming material is melt-kneaded at a temperature of t1° C. in the kneading unit NA. The binder resin and the releasing agent become molten in the kneading unit NA and subjected to shear by the screw.

Next, the toner particle-forming material kneaded in the kneading unit NA is fed to the kneading unit NB by the feed screw unit SB.

Subsequently, an aqueous medium is injected through the liquid addition port 16 to the barrel 12 in the feed screw unit SB so as to add the aqueous medium to the toner particle-forming material. Although FIG. 1 illustrates a mode where the aqueous medium is injected in the feed screw unit SB, this feature is not limiting, and the aqueous medium may be injected in the kneading unit NB or in both the feed screw unit SB and the kneading unit NB. In other words, the position and the injection site of injecting the aqueous medium are selected as necessary.

By injecting the aqueous medium through the liquid addition port 16 to the barrel 12 as described above, the toner particle-forming material in the barrel 12 mixes with the aqueous medium, the toner particle-forming material is cooled by the evaporative latent heat of the aqueous medium, and the temperature of the toner particle-forming material is maintained.

Lastly, the kneaded material formed by melt-kneading in the kneading unit NB is conveyed to the discharge port 18 by the feed screw unit SC and discharged from the discharge port 18.

As such, the kneading step using the screw extruder 11 illustrated in FIG. 1 is performed.

### Cooling Step

The cooling step is a step of cooling the kneaded material formed by the aforementioned kneading step, and, in the cooling step, the kneaded material may be cooled from the temperature at the end of the kneading step to a temperature equal to or lower than 40° C. at an average cooling rate of 4° C./sec or more. When the kneaded material cooling rate is slow, the mixture (mixture of the toner particle-forming material) finely dispersed in the binder resin in the kneading step recrystallizes, and the dispersion diameter may increase. In contrast, when rapid cooling is performed at the aforementioned average cooling rate, the dispersed state immediately after the end of the kneading step is maintained. Here, the average cooling rate refers to an average of the rate at which the temperature of the kneaded material is decreased from the temperature at the end of the kneading step (for example, when the screw extruder 11 illustrated in FIG. 1 is used, the temperature is t2° C.) to 40° C.

Specific examples of the cooling method employed in the cooling step include a method that uses a rolling roll in which cooling water or brine is circulated, and an insertion-type cooling belt. When such a method is used in cooling, the cooling rate is determined by the speed of the rolling roll, the flow rate of the brine, the feed amount of the kneaded material, the slab thickness of the kneaded material during rolling, etc. The slab thickness may be 1 to 3 mm.

### Pulverizing Step

The kneaded material cooled in the cooling step is pulverized in the pulverizing step to form toner particles. In the pulverizing step, for example, a mechanical pulverizer, a jet pulverizer, etc., are used.

### Classifying Step

If necessary, the particles obtained in the pulverizing step may be classified in a classifying step in order to obtain toner particles having a volume-average particle size in the intended range. In the classifying step, a centrifugal classifier, an inertial classifier, etc., that have been typically used are used, and fine powder (particles having a particle size smaller than the intended range) and coarse powder (particles having a particle size larger than the intended range) are removed.

### External Addition Step

To the obtained toner particles, an external additive (for example, oil-treated silica particles) is added and attached. This is carried out by using a V-type blender, a Henschel mixer, a Loedige mixer, or the like, and the external additive is attached in multiple stages.

### Sieving Step

After the aforementioned external addition step, a sieving step may be provided as necessary. Specific examples of the sieving method include methods that use a gyro sifter, a vibrating sifter, a wind sifter, etc. Sieving removes coarse particles in the external additive, etc., and suppresses occurrence of steaks on a photoreceptor, contamination blots in the apparatus etc.

### Electrostatic Charge Image Developer

An electrostatic charge image developer of an exemplary embodiment contains at least the toner of the present exemplary embodiment.

The electrostatic charge image developer of the exemplary embodiment may be a one-component developer that contains only the toner of the present exemplary embodiment or a two-component developer which is a mixture of the toner and a carrier.

The carrier is not particularly limited, and an example thereof is a known carrier. Examples of the carrier include a coated carrier obtained by covering a surface of a core formed of a magnetic powder with a coating resin; a magnetic powder-dispersed carrier in which a magnetic powder is dispersed and blended in a matrix resin; and a resin-impregnated carrier in which a porous magnetic powder is impregnated with a resin.

The magnetic powder-dispersed carrier and the resin-impregnated carrier may each be constituted by a core formed of a constituent particle of the carrier, and a coating resin covering the core.

Examples of the magnetic powder include magnetic metals such as iron, nickel, and cobalt, and magnetic oxides such as ferrite and magnetite. In particular, the magnetic powder may be magnetite or ferrite. The magnetic powder may be used as particles in which a magnetic powder is dispersed in a resin.

Examples of the coating resin and the matrix resin include styrene-(meth)acrylic acid resins; polyolefin resins such as polyethylene resins and polypropylene resins; polyvinyl or polyvinylidene resins such as polystyrene, (meth)acrylic resins, polyacrylonitrile, polyvinyl acetate, polyvinyl alcohol, polyvinyl butyral, polyvinyl chloride, polyvinyl carbazole, polyvinyl ether, and polyvinyl ketone; vinyl chloride-vinyl acetate copolymers; straight silicone resins containing organosiloxane bonds and modified products thereof; fluororesins such as polytetrafluoroethylene, polyvinyl fluoride, polyvinylidene fluoride, and polychlorotrifluoroethylene; polyesters; polyurethanes; polycarbonates; amino resins such as urea-formaldehyde resins; and epoxy resins.

The coating resin and the matrix resin may contain a (meth)acrylic resin or a (meth)acrylic resin having an alicyclic structure. The coating resin and the matrix resin may contain nitrogen-containing (meth)acrylic resin.

The (meth)acrylic resin is preferably contained in an amount of 50 mass % or more relative to the total mass of the resin, and is more preferably contained in an amount of 80 mass % or more relative to the total mass of the resin.

In particular, the coating resin and the matrix resin may contain, as the (meth)acrylic resin, an alicyclic (meth)acrylic resin.

The coating resin and the matrix resin may each contain other additives such as conductive particles.

Examples of the conductive particles include particles of metals such as gold, silver, and copper, and particles of carbon black, titanium oxide, zinc oxide, tin oxide, barium sulfate, aluminum borate, and potassium titanate.

Examples of other additives include, although some particle may overlap the aforementioned conductive particles, metal oxide particles such as silica, titanium oxide, zinc oxide, and tin oxide; metal compound particles such as barium sulfate, aluminum borate, and potassium titanate; and metal particles such as gold, silver, and copper. Among these, silica particles may be used.

The aforementioned particles may be contained in an amount of 10 mass % or more and 60 mass % or less relative to the total mass of the resin layer.

An example of the method for coating the surface of the core with a resin is a method that involves coating the surface of the core with a coating layer-forming solution prepared by dissolving a coating resin and, if necessary, various additives in an appropriate solvent. The solvent is not particularly limited, and may be selected by considering the type of the coating resin used, application suitability, etc.

Specific examples of the resin coating method include a dipping method that involves dipping a core in a coating layer-forming solution, a spraying method that involves spraying a coating layer-forming solution onto the surface of the core, a flow bed method that involves spraying a coating layer-forming solution while the core floats on flowing air, and a kneader coater method that involves mixing the core for the carrier and a coating layer-forming solution in a kneader coater and removing the solvent.

The toner-to-carrier mixing ratio (mass ratio) in the two-component developer is preferably 1:100 to 30:100, and more preferably 3:100 to 20:100.

### Image Forming Apparatus and Image Forming Method

An image forming apparatus and an image forming method according to exemplary embodiments will now be described.

An image forming apparatus according to an exemplary embodiment includes an image bearing member, a charging device that charges a surface of the image bearing member, an electrostatic charge image forming device that forms an electrostatic charge image on the charged surface of the image bearing member, a developing device that stores an electrostatic charge image developer and develops the electrostatic charge image on the surface of the image bearing member into a toner image by using the electrostatic charge image developer, a transfer device that transfers the toner image on the surface of the image bearing member onto a surface of a recording medium, and a fixing device that fixes the transferred toner image on the surface of the recording medium. Here, the electrostatic charge image developer of the present exemplary embodiment is employed as the electrostatic charge image developer.

The image forming apparatus of the present exemplary embodiment is used to implement an image forming method (the image forming method of the present exemplary embodiment) that involves a charging step of charging a surface of an image bearing member, an electrostatic charge image forming step of forming an electrostatic charge image on the charged surface of the image bearing member, a developing step of developing the electrostatic charge image on the surface of the image bearing member into a toner image by using the electrostatic charge image developer of the exemplary embodiment, a transfer step of transferring the toner image on the surface of the image bearing member onto a surface of a recording medium, and a fixing step of fixing the transferred toner image on the surface of the recording medium.

The image forming apparatus of the present exemplary embodiment may be, for example, a known image forming apparatus such as a direct transfer type apparatus with which a toner image formed on a surface of an image bearing member is directly transferred onto a recording medium; an intermediate transfer type apparatus with which a toner image formed on a surface of an image bearing member is first transferred onto a surface of an intermediate transfer body and then the toner image on the intermediate transfer body is transferred for the second time onto a surface of a recording medium; an apparatus equipped with a cleaning device that cleans the surface of an image bearing member after the transfer of the toner image and before charging; or an apparatus equipped with a charge erasing device that irradiates the surface of an image bearing member with charge erasing light to remove charges after the transfer of the toner image and before charging.

When the intermediate transfer type apparatus is used, the transfer device has, for example, a structure that includes an intermediate transfer body having a surface that receives the transfer of a toner image, a first transfer device that performs first transfer of transferring the toner image on the surface of the image bearing member onto a surface of the intermediate transfer body, and a second transfer device that performs second transfer of transferring the transferred toner image on the surface of the intermediate transfer body onto a surface of a recording medium.

It should be noted that, in the image forming apparatus of the present exemplary embodiment, for example, a portion that includes the developing device may have a cartridge structure (process cartridge) detachably attachable to the image forming apparatus. An example of the process cartridge is a process cartridge that includes a developing device that stores the charge image developer of the present exemplary embodiment.

Hereinafter, one example of the image forming apparatus of the exemplary embodiment is described, but this exemplary embodiment is not limiting. It should be noted that only the relevant portions illustrated in the drawings are described, and other descriptions are omitted.

In the description below, a six-unit tandem-system image forming apparatus in which six image forming units are arranged side-by-side is described as an example of the image forming apparatus of the present exemplary embodiment. The tandem-system image forming apparatus is not limited to this and may be a five-unit tandem-system image forming apparatus in which five image forming units are arranged side-by-side or a four-unit tandem-system image forming apparatus in which four image forming units are arranged side-by-side.

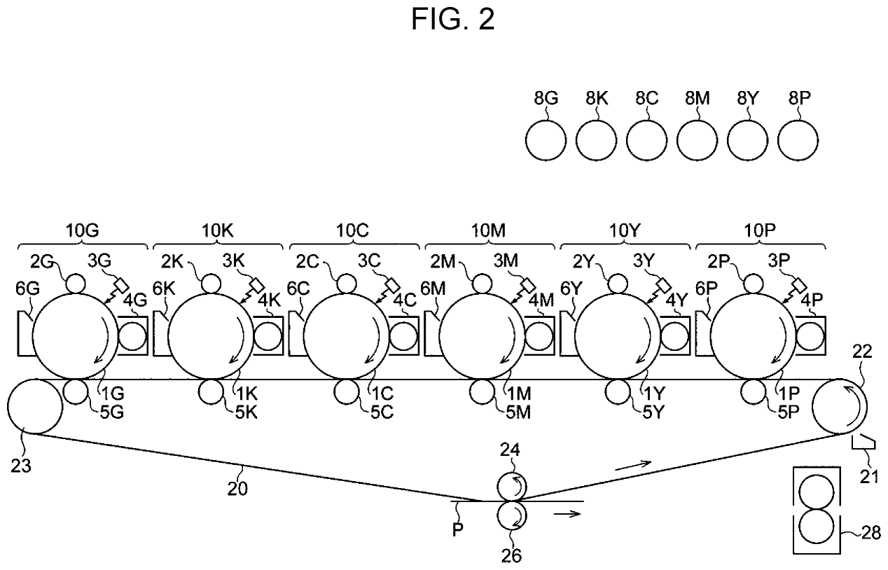

FIG. 2 is a schematic diagram illustrating an image forming apparatus according to the present exemplary embodiment and illustrates a six-unit tandem-system, intermediate transfer-type image forming apparatus.

The image forming apparatus illustrated in FIG. 2 includes first to sixth image forming units 10P, 10Y, 10M, 10C, 10K, and 10G which are electrophotographic image forming units that respectively output pink (P), yellow (Y), magenta (M), cyan (C), black (K), and green (G) images on the basis of color-separated image data. These image forming units (hereinafter may also be referred simply as “units”) 10P, 10Y, 10M, 10C, 10K, and 10G are arranged side-by-side and spaced from each other by a predetermined distance in the horizontal direction. These units 10P, 10Y, 10M, 10C, 10K, and 10G may be process cartridges that are detachably attachable to the image forming apparatus.

An intermediate transfer belt (one example of the intermediate transfer body) 20 that extends across all of the units is disposed under the units 10P, 10Y, 10M, 10C, 10K, and 10G. The intermediate transfer belt 20 is wound around a drive roll 22, a support roll 23, and a counter roll 24 that contact the inner surface of the intermediate transfer belt 20 and is designed to run in a direction heading toward the sixth unit 10G from the first unit 10P. An intermediate transfer body cleaning device 21 that faces the drive roll 22 is disposed on the image bearing surface-side of the intermediate transfer belt 20.

Pink, yellow, magenta, cyan, black, and green toners stored in toner cartridges 8P, 8Y, 8M, 8C, 8K, and 8G are respectively fed to developing devices (one example of the developing device) 4P, 4Y, 4M, 4C, 4K, and 4G of the units 10P, 10Y, 10M, 10C, 10K, and 10G.

Since the first to sixth units 10P, 10Y, 10M, 10C, 10K, and 10G are identical in structure and operation, the sixth unit 10G that forms a green image is described as a representative example.

Here, for example, the toner according to the aforementioned present exemplary embodiment is used as the toner for forming the green image.

The sixth unit 10G includes a photoreceptor 1G that serves as an image bearing member. A charging roll (one example of the charging device) 2G that charges the surface of the photoreceptor 1G to a predetermined potential, an exposing device (one example of the electrostatic charge image forming device) 3G that exposes the charged surface with a laser beam on the basis of color-separated image signals to form an electrostatic charge image, a developing device (one example of the developing device) 4G that feeds the toner to the electrostatic charge image to develop the electrostatic charge image, a first transfer roll (one example of the first transfer device) 5G that transfers the developed toner image onto the intermediate transfer belt 20, and a photoreceptor cleaning device (one example of the cleaning device) 6G that removes the toner that remains on the surface of the photoreceptor 1G after the first transfer are disposed around the photoreceptor 1G in this order.

The first transfer roll 5G is disposed on the inner side of the intermediate transfer belt 20 and faces the photoreceptor 1G. The first transfer rolls 5Y, 5P, 5M, 5C, 5G, and 5K of the respective units are each connected to a bias power supply (not illustrated) that applies a first transfer bias. Each of the bias power supplies is controlled by a controller not illustrated in the drawing so that the transfer bias applied to each of the first transfer rolls is changed.

Hereinafter, operation of forming a green image in the sixth unit 10G is described.

First, before starting the operation, the surface of the photoreceptor 1G is charged by the charging roll 2G to a potential of −600 V to −800 V.

The photoreceptor 1G is formed by stacking a photosensitive layer on a conductive (for example, volume resistivity at 20° C.: 1×10⁻⁶ Ω·cm or less) base. This photosensitive layer normally has a high resistance (a resistance of a general resin); however, once irradiated with a laser beam, the portion exposed to the laser beam exhibits a change in resistivity. Then the charged surface of the photoreceptor 1G is irradiated with a laser beam from the exposing device 3G in accordance with the green image data sent from a controller not illustrated in the drawing. As a result, an electrostatic charge image of the green image pattern is formed on the surface of the photoreceptor 1G.

An electrostatic charge image is an image formed on the surface of the photoreceptor 1G as a result of charging, and is a negative latent image formed as the decrease in resistivity of the portion of the photosensitive layer irradiated with the laser beam from the exposing device 3G causes charges to flow out of the surface of the photoreceptor 1G while the charges in the portions not irradiated with the laser beam remain.

The electrostatic charge image formed on the photoreceptor 1G is rotated to a predetermined development position as the photoreceptor 1G is run. At this development position, the electrostatic charge image on the photoreceptor 1G is developed and visualized as a toner image by the developing device 4G.

In the developing device 4G, an electrostatic charge image developer that contains at least a green toner and a carrier is stored. The green toner is frictionally charged by being stirred inside the developing device 4G, gains charges having the same polarity (negative polarity) as the charges on the photoreceptor 1G, and retained on a developer roll (one example of the developer bearing body). Then, as the surface of the photoreceptor 1G passes through the developing device 4G, the green toner electrostatically attach to the charge-erased latent image portion on the surface of the photoreceptor 1G, and the latent image is developed with the green toner. The photoreceptor 1G on which the green toner image is formed keeps running at a predetermined speed, and the developed toner image on the photoreceptor 1G is conveyed to a predetermined first transfer position.

Once the green toner image on the photoreceptor 1G is conveyed to the first transfer position, a first transfer bias is applied to the first transfer roll 5G, an electrostatic force acting from the photoreceptor 1G toward the first transfer roll 5G acts on the toner image, and the toner image on the photoreceptor 1G is transferred onto the intermediate transfer belt 20. Here, the applied transfer bias has a polarity (+) opposite to the polarity (−) of the toner, and is controlled to, for example, +10 μA in the first unit 10G by a controller (not illustrated).

After the toner image is transferred onto the intermediate transfer belt 20, the photoreceptor 1G keeps rotating and comes into contact with a cleaning blade installed in the photoreceptor cleaning device 6G. The toner remaining on the photoreceptor 1G is removed and recovered in the photoreceptor cleaning device 6G.

The intermediate transfer belt 20 is sequentially conveyed through the first to sixth image forming units 10P, 10Y, 10M, 10C, 10K, and 10G, and toner images of respective colors are stacked to achieve multilayer transfer.

After the multilayer transfer of toner images of six colors through the first to sixth units, the intermediate transfer belt 20 reaches a second transfer portion constituted by the intermediate transfer belt 20, the counter roll 24 in contact with the inner surface of the intermediate transfer belt 20, and a second transfer roll (one example of the second transfer device) 26 disposed on the image bearing surface-side of the intermediate transfer belt 20. Meanwhile, a recording paper sheet (one example of the recording medium) P is fed, via a feeding mechanism, at a predetermined timing into the gap where the second transfer roll 26 contacts the intermediate transfer belt 20, and a second transfer bias is applied to the counter roll 24. The transfer bias applied here has the same polarity (−) as the polarity (−) of the toner, an electrostatic force acting from the intermediate transfer belt 20 toward the recording paper sheet P acts on the toner images, and the toner images on the intermediate transfer belt 20 are transferred onto the recording paper sheet P. The second transfer bias applied during this process is determined according to the resistance detected with a resistance detector (not illustrated) that detects the resistance of the second transfer portion, and is voltage-controlled.

After the toner images are transferred onto the recording paper sheet P, the intermediate transfer belt 20 keeps running and comes into contact with a cleaning blade installed in the intermediate transfer body cleaning device 21. The toner remaining on the intermediate transfer belt 20 is removed and recovered in the intermediate transfer body cleaning device 21.

The recording paper sheet P onto which the toner images have been transferred is fed to a contact portion (nip portion) of a pair of fixing rolls in a fixing device (one example of the fixing device) 28, and the toner images are fixed onto the recording paper sheet P to form a fixed image.

Examples of the recording paper sheet P onto which the toner images are transferred include regular paper used in electrophotographic copiers and printers, etc. Examples of the recording medium other than the recording paper sheet P include OHP sheets.

In order to further improve the smoothness of the image surface after fixing, the surface of the recording paper sheet P may also be smooth, and, for example, a coated paper sheet obtained by coating a surface of a regular paper sheet with a resin or the like, art paper for printing, etc., are used.

After completion of fixing of the color images, the recording paper sheet P is conveyed toward a discharge portion, and a series of color image forming operations come to an end.

### Process Cartridge and Toner Cartridge

A process cartridge according to an exemplary embodiment will now be described.

A process cartridge according to this exemplary embodiment is detachably attachable to an image forming apparatus and includes a developing device that stores the electrostatic charge image developer of the present exemplary embodiment and develops an electrostatic charge image on a surface of an image bearing member into a toner image by using the electrostatic charge image developer.

The process cartridge of the exemplary embodiment is not limited to the one having the aforementioned structure, and may have a structure that includes a developing device and, if needed, at least one selected from other devices such as an image bearing body, a charging device, an electrostatic charge image forming device, and a transfer device, for example.

Hereinafter, one example of the process cartridge of the exemplary embodiment is described, but this example is not limiting. In the description below, only the relevant portions illustrated in the drawings are described, and other descriptions are omitted.

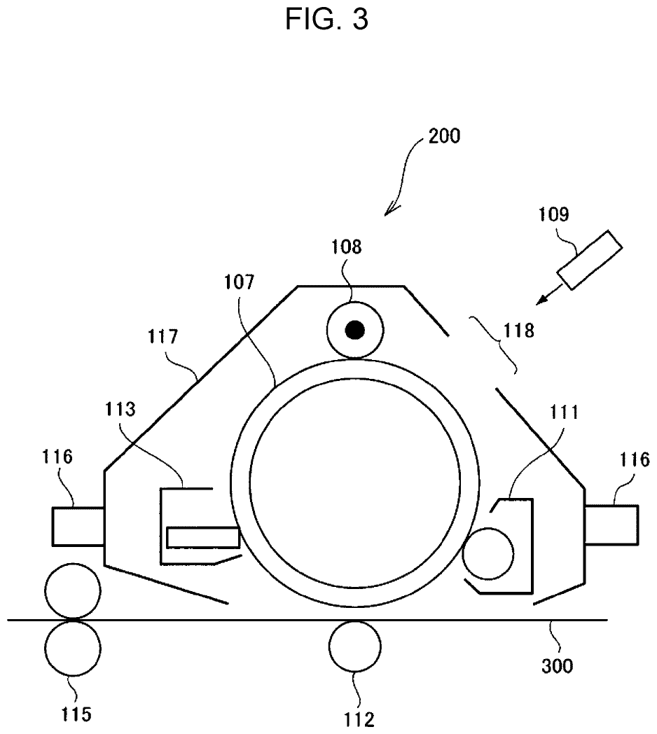

FIG. 3 is a schematic diagram illustrating a process cartridge according to an exemplary embodiment.

A process cartridge 200 illustrated in FIG. 3 includes a housing 117 that includes an installation rail 116 and an aperture 118 for exposure, and this housing 117 integrates, assembles, and retains a photoreceptor 107 (one example of the image bearing body), and a charging roll 108 (one example of the charging device), a developing device 111 (one example of the developing device), and a photoreceptor cleaning device 113 (one example of the cleaning device) that are disposed around the photoreceptor 107 so as to form a cartridge.

In FIG. 3, reference sign 109 denotes an exposing device (one example of an electrostatic charge image forming device), 112 denotes a transfer device (one example of the transfer device), 115 denotes a fixing device (one example of the fixing device), and 300 denotes a recording paper sheet (one example of the recording medium).

Next, a toner cartridge according to an exemplary embodiment is described.

The toner cartridge according to this exemplary embodiment stores a green toner of the present exemplary embodiment and is detachably attachable to the image forming apparatus. The toner cartridge is for storing an extra toner to be supplied to the developing device installed in the image forming apparatus.

The image forming apparatus illustrated in FIG. 2 has a structure in which the toner cartridges 8P, 8Y, 8M, 8C, 8K, and 8G are detachably attached, and the developing devices 4P, 4Y, 4M, 4C, 4K, and 4G are respectively connected to the toner cartridges of corresponding colors via toner supply tubes not illustrated in the drawing. Furthermore, when the amount of the toner stored in the toner cartridge has decreased, the toner cartridge is replaced. One example of the toner cartridge of the present exemplary embodiment is the toner cartridge 8G, and the toner of the present exemplary embodiment is stored. The toner cartridges 8P, 8Y, 8M, 8C, and 8K respectively store pink yellow, magenta, cyan, and black toners.

### EXAMPLES

The exemplary embodiments of the present disclosure will now be described in detail through examples; however, the exemplary embodiments of the present disclosure are not limited to these examples.

In the description below, “parts” and “%” are all on a mass basis unless otherwise noted. Synthesis, treatment, production, etc., are carried out at room temperature (25° C.±3° C.) unless otherwise noted.

### Preparation of Polyester Resin (1)

terephthalic acid: 30 parts by mol
fumaric acid: 70 parts by mol
bisphenol A ethylene oxide adduct: 5 parts by mol
bisphenol A propylene oxide adduct: 95 parts by mol

Into a flask equipped with a stirrer, a nitrogen inlet tube, a temperature sensor, and a distillation column, the aforementioned material are charged, and the temperature is elevated to 220° C. over a period of 1 hour. After the temperature is elevated, 1 part of titanium tetraethoxide is added to 100 parts of the aforementioned materials. The temperature is elevated to 230° C. over a period of 30 minutes while distilling away the generated water, the dehydration and condensation reaction is continued at the aforementioned temperature for 1 hour, and then the reaction product is cooled. As a result, a polyester resin (1) having a weight-average molecular weight of 18,000 and a glass transition temperature of 60° C. is obtained.

### Preparation of Coloring Agent-Dispersed Particles (1)

fluorescent yellow pigment (C.I. Pigment Yellow 101 (Radglo VSF-0-01 produced by RADIANT COLOR NV, emission peak wavelength: 520 nm)): 70 parts
anionic surfactant (NEOGEN RK produced by DKS Co. Ltd.): 30 parts (solid component concentration: 20%)

The aforementioned components are mixed and pulverized with a continuous-type key mill (KMC-3) down to 300 nm to obtain coloring agent-dispersed particles (1).

### Preparation of Coloring Agent-Dispersed Particles (2)

non-fluorescent green pigment (C.I. Pigment Green 36 (LIONOL GREEN 8624 produced by Toyocolor Co., Ltd., reflection peak wavelength: 510 nm)): 70 parts
anionic surfactant (NEOGEN RK produced by DKS Co. Ltd.): 30 parts (solid component concentration: 20%)

The aforementioned components are mixed and pulverized with a continuous-type key mill (KMC-3) down to 150 nm to obtain coloring agent-dispersed particles (2).

### Preparation of Coloring Agent-Dispersed Particles (3)

fluorescent yellow pigment (Radglo VSF-0-05 produced by RADIANT COLOR NV, emission peak wavelength: 519 nm): 70 parts
anionic surfactant (NEOGEN RK produced by DKS Co. Ltd.): 30 parts (solid component concentration: 20%)

The aforementioned components are mixed and pulverized with a continuous-type key mill (KMC-3) down to 300 nm to obtain coloring agent-dispersed particles (3).

### Preparation of Coloring Agent-Dispersed Particles (4)

fluorescent yellow pigment (C.I. Pigment Yellow 101 (Radglo VSF-0-01 produced by RADIANT COLOR NV, emission peak wavelength: 520 nm)): 70 parts
anionic surfactant (NEOGEN RK produced by DKS Co. Ltd.): 30 parts (solid component concentration: 20%)

The aforementioned components are mixed and pulverized with a continuous-type key mill (KMC-3) down to 100 nm to obtain coloring agent-dispersed particles (4).

### Preparation of Coloring Agent-Dispersed Particles (5)

fluorescent yellow pigment (C.I. Pigment Yellow 101 (Radglo VSF-0-01 produced by RADIANT COLOR NV, emission peak wavelength: 520 nm)): 70 parts
anionic surfactant (NEOGEN RK produced by DKS Co. Ltd.): 30 parts (solid component concentration: 20%)

The aforementioned components are mixed and pulverized with a continuous-type key mill (KMC-3) down to 150 nm to obtain coloring agent-dispersed particles (5).

### Preparation of Coloring Agent-Dispersed Particles (6)

fluorescent yellow pigment (C.I. Pigment Yellow 101 (Radglo VSF-0-01 produced by RADIANT COLOR NV, emission peak wavelength: 520 nm)): 70 parts
anionic surfactant (NEOGEN RK produced by DKS Co. Ltd.): 30 parts (solid component concentration: 20%)

The aforementioned components are mixed and pulverized with a continuous-type key mill (KMC-3) down to 450 nm to obtain coloring agent-dispersed particles (6).

### Preparation of Coloring Agent-Dispersed Particles (7)

fluorescent yellow pigment (C.I. Pigment Yellow 101 (Radglo VSF-0-01 produced by RADIANT COLOR NV, emission peak wavelength: 520 nm)): 70 parts
anionic surfactant (NEOGEN RK produced by DKS Co. Ltd.): 30 parts (solid component concentration: 20%)

The aforementioned components are mixed and pulverized with a continuous-type key mill (KMC-3) down to 500 nm to obtain coloring agent-dispersed particles (7).

### Preparation of Oil-Treated Silica Particles (1)

SiCl₄, hydrogen gas, and oxygen gas are mixed in a mixing chamber of a combustion burner, and the resulting mixture is combusted at a temperature of 1000° C. or higher and 3000° C. or lower. Silica powder is taken out of the combusted gas to obtain silica particles. Here, the molar ratio of hydrogen gas to oxygen gas is set to 1.35:1 to obtain silica particles (R1) having a volume-average particle size (D50v) of 100 nm.

Into an evaporator, 100 parts of silica particles (R1) and 500 parts of ethanol are placed, and the resulting mixture is stirred for 15 minutes while maintaining the temperature at 40° C. Next, 10 parts of dimethylsilicone oil is added to 100 parts of the silica particles (R1), followed by stirring for 15 minutes. Subsequently, 15 parts of dimethylsilicone oil is further added to 100 parts of the silica particles (R1), followed by stirring for 15 minutes. Lastly, the temperature is elevated to 90° C., and ethanol is dried at a reduced pressure. Then the treated product is taken out and vacuum-dried at 120° C. for 30 minutes to obtain oil-treated silica particles (1) having a volume-average particle size (D50v) of 100 nm and containing 20 mass % of free oil.

### Preparation of Oil-Treated Silica Particles (2)

Oil-treated silica particles (2) are obtained by the same process as that for the oil-treated silica particles (1) except that, in the production of the oil-treated silica particles (1), instead of 10 parts, 16 parts of dimethylsilicone oil relative to 100 parts of the silica particles is added, the resulting mixture is stirred for 15 minutes, and then, instead of 15 parts, 18 parts of dimethylsilicone oil is further added relative to 100 parts of the silica particles.

### Preparation of Oil-Treated Silica Particles (3)

SiCl₄, hydrogen gas, and oxygen gas are mixed in a mixing chamber of a combustion burner, and the resulting mixture is combusted at a temperature of 1000° C. or higher and 3000° C. or lower. Silica powder is taken out from the combusted gas to obtain silica particles. Here, the molar ratio of hydrogen gas to oxygen gas is set to 1.15:1 to obtain silica particles (R2) having a volume-average particle size (D50v) of 18 nm.

Into an evaporator, 100 parts of silica particles (R2) and 500 parts of ethanol are placed, and the resulting mixture is stirred for 15 minutes while maintaining the temperature at 40° C. Next, 10 parts of dimethylsilicone oil is added to 100 parts of the silica particles (R2), followed by stirring for 15 minutes. Subsequently, 15 parts of dimethylsilicone oil is further added to 100 parts of the silica particles (R2), followed by stirring for 15 minutes. Lastly, the temperature is elevated to 90° C., and ethanol is dried at a reduced pressure. Then the treated product is taken out and vacuum-dried at 120° C. for 30 minutes to obtain oil-treated silica particles (3) having a volume-average particle size (D50v) of 18 nm and containing 23 mass % of free oil.

### Preparation of Oil-Treated Silica Particles (4)

SiCl₄, hydrogen gas, and oxygen gas are mixed in a mixing chamber of a combustion burner, and the resulting mixture is combusted at a temperature of 1000° C. or higher and 3000° C. or lower. Silica powder is taken out from the combusted gas to obtain silica particles. Here, the molar ratio of hydrogen gas to oxygen gas is set to 1.45:1 to obtain silica particles (R3) having a volume-average particle size (D50v) of 194 nm.

Into an evaporator, 100 parts of silica particles (R3) and 500 parts of ethanol are placed, and the resulting mixture is stirred for 15 minutes while maintaining the temperature at 40° C. Next, 10 parts of dimethylsilicone oil is added to 100 parts of the silica particles (R3), followed by stirring for 15 minutes. Subsequently, 15 parts of dimethylsilicone oil is further added to 100 parts of the silica particles (R3), followed by stirring for 15 minutes. Lastly, the temperature is elevated to 90° C., and ethanol is dried at a reduced pressure. Then the treated product is taken out and vacuum-dried at 120° C. for 30 minutes to obtain oil-treated silica particles (4) having a volume-average particle size (D50v) of 194 nm and containing 13 mass % of free oil.

### Preparation of Oil-Treated Silica Particles (5)

Oil-treated silica particles (5) are obtained by the same process as that for the oil-treated silica particles (1) except that, in the production of the oil-treated silica particles (1), instead of 10 parts, 5 parts of dimethylsilicone oil relative to 100 parts of the silica particles (R1) is added, the resulting mixture is stirred for 15 minutes, and then, instead of 15 parts, 5 parts of dimethylsilicone oil is further added relative to 100 parts of the silica particles.

### Preparation of Oil-Treated Silica Particles (6)

Oil-treated silica particles (6) are obtained by the same process as that for the oil-treated silica particles (1) except that, in the production of the oil-treated silica particles (1), instead of 10 parts, 8 parts of dimethylsilicone oil relative to 100 parts of the silica particles (R1) is added, the resulting mixture is stirred for 15 minutes, and then, instead of 15 parts, 10 parts of dimethylsilicone oil is further added relative to 100 parts of the silica particles.

### Preparation of Oil-Treated Silica Particles (7)

Oil-treated silica particles (7) are obtained by the same process as that for the oil-treated silica particles (1) except that, in the production of the oil-treated silica particles (1), instead of 10 parts, 18 parts of dimethylsilicone oil relative to 100 parts of the silica particles (R1) is added, the resulting mixture is stirred for 15 minutes, and then, instead of 15 parts, 20 parts of dimethylsilicone oil is further added relative to 100 parts of the silica particles.

### Preparation of Oil-Treated Silica Particles (8)

SiCl₄, hydrogen gas, and oxygen gas are mixed in a mixing chamber of a combustion burner, and the resulting mixture is combusted at a temperature of 1000° C. or higher and 3000° C. or lower. Silica powder is taken out from the combusted gas to obtain silica particles. Here, the molar ratio of hydrogen gas to oxygen gas is set to 1.05:1 to obtain silica particles (R4) having a volume-average particle size (D50v) of 13 nm.

Oil-treated silica particles (8) are obtained by the same process as that for the oil-treated silica particles (1) except that, the silica particles (R1) used in producing the oil-treated silica particles (1) are changed to the silica particles (R4).

### Preparation of Oil-Treated Silica Particles (9)

SiCl₄, hydrogen gas, and oxygen gas are mixed in a mixing chamber of a combustion burner, and the resulting mixture is combusted at a temperature of 1000° C. or higher and 3000° C. or lower. Silica powder is taken out from the combusted gas to obtain silica particles. Here, the molar ratio of hydrogen gas to oxygen gas is set to 1.55:1 to obtain silica particles (R5) having a volume-average particle size (D50v) of 212 nm.

Oil-treated silica particles (9) are obtained by the same process as that for the oil-treated silica particles (1) except that, the silica particles (R1) used in producing the oil-treated silica particles (1) are changed to the silica particles (R5).

### Preparation of Oil-Treated Silica Particles (10)

Oil-treated silica particles (10) are obtained by the same process as that for the oil-treated silica particles (1) except that, in the production of the oil-treated silica particles (1), instead of 10 parts, 3 parts of dimethylsilicone oil relative to 100 parts of the silica particles (R1) is added, the resulting mixture is stirred for 15 minutes, and then, instead of 15 parts, 5 parts of dimethylsilicone oil is further added relative to 100 parts of the silica particles.

### Preparation of Oil-Treated Silica Particles (11)

Oil-treated silica particles (11) are obtained by the same process as that for the oil-treated silica particles (1) except that, instead of 10 parts, 15 parts of dimethylsilicone oil relative to 100 parts of the silica particles (R1) is added, the resulting mixture is stirred for 15 minutes, and then, instead of 15 parts, 18 parts of dimethylsilicone oil is further added relative to 100 parts of the silica particles (R1).

### Example 1

### Preparation of Toner Particles (1)

polyester resin (1): 560 parts
coloring agent-dispersed particles (1): 70 parts
coloring agent-dispersed particles (2): 30 parts
paraffin wax (HNP-9 produced by Nippon Seiro Co., Ltd.): 30 parts
anionic surfactant (NEOGEN RK produced by DKS Co. Ltd., 20%): 12 parts

The aforementioned raw materials are pre-mixed in a Henschel mixer and kneaded under the following conditions by using a twin-screw extrusion kneader having a feed-kneading-feed-kneading-feed unit screw structure.

The screw speed is set to 500 revolutions per minute (rpm), and the feed amount is 80 kg. In addition, in the middle feed unit, an aqueous medium containing 1.5 parts of distilled water and 0.02 parts of an anionic surfactant (NEOGEN RK produced by DKS Co. Ltd.) is added to 100 parts of the fed raw materials. The kneaded mixture is slowly cooled at 10° C./sec or less by using a rolling roll in which brine is passed, and a slab-insertion-type cooling belt cooled with cold water, and the cooled mixture is roughly pulverized by using a pin mill and is then pulverized by a hammer mill. Next, the mixture is pulverized by a pulverizer (AFG400) installed in the rough particle pulverizing and classifying machine to obtain toner particles (1) having a desired particle size.

To 100 parts of the obtained toner particles (1), 1.5 parts of oil-treated silica particles (1) and 1.0 part of hydrophobic titanium oxide (T805 produced by Nippon Aerosil Co., Ltd.) are mixed and blended by using a sample mill at 10,000 revolutions per minute (rpm) for 30 seconds. The resulting mixture is then sieved with a vibrating sieve with 45 μm openings to obtain a toner (1).

### Example 2

Toner particles and a toner are obtained as in Example 1 except that, in the production of toner particles (1), 20 parts of the coloring agent-dispersed particles (1) and 50 parts of the coloring agent-dispersed particles (2) are used.

### Example 3

Toner particles and a toner are obtained as in Example 1 except that, in the production of toner particles (1), 35 parts of the coloring agent-dispersed particles (1) and 8 parts of the coloring agent-dispersed particles (2) are used.

### Example 4

Toner particles and a toner are obtained as in Example 1 except that, in the production of toner particles (1), 130 parts of the coloring agent-dispersed particles (1) and 60 parts of the coloring agent-dispersed particles (2) are used.

### Example 5

Toner particles and a toner are obtained as in Example 1 except that, in the production of toner particles (1), 160 parts of the coloring agent-dispersed particles (1) are used.

### Example 6

Toner particles and a toner are obtained as in Example 1 except that, in the production of toner particles (1), the amount of the anionic surfactant (NEOGEN RK produced by DKS Co. Ltd., 20%) used in pre-mixing in a Henschel mixer is changed from 12 parts to 24 parts, and, in the middle feed unit, the amount of the anionic surfactant (NEOGEN RK produced by DKS Co. Ltd.) relative to 100 parts of the feed raw materials is changed from 0.02 parts to 0.04 parts.

### Example 7

Toner particles are obtained as in Example 1 except that, in the production of toner particles (1), 40 parts of the coloring agent-dispersed particles (4) are used.

A toner is obtained as in Example 1 except that, in the production of toner (1), the obtained toner particles and the oil-treated silica particles (2) are used.

### Example 8

Toner particles are obtained as in Example 1 except that, in the production of toner particles (1), 50 parts of the coloring agent-dispersed particles (4) are used.

A toner is obtained as in Example 1 except that, in the production of toner (1), the obtained toner particles and the oil-treated silica particles (3) are used.

### Example 9

Toner particles are obtained as in Example 1 except that, in the production of toner particles (1), 150 parts of the coloring agent-dispersed particles (4) are used.

A toner is obtained as in Example 1 except that, in the production of toner (1), the obtained toner particles and the oil-treated silica particles (4) are used.

### Example 10

Toner particles are obtained as in Example 1 except that, in the production of toner particles (1), 150 parts of the coloring agent-dispersed particles (5) are used.

A toner (9) is obtained as in Example 1 except that, in the production of toner (1), the obtained toner particles are used.

### Example 11

A toner is obtained as in Example 1 except that, in the production of toner (1), the amount of the oil-treated silica particles is changed from 1.5 parts to 0.3 parts.

### Example 12

A toner is obtained as in Example 1 except that, in the production of toner (1), the amount of the oil-treated silica particles is changed from 1.5 parts to 0.6 parts.

### Example 13

A toner is obtained as in Example 1 except that, in the production of toner (1), the amount of the oil-treated silica particles is changed from 1.5 parts to 4.8 parts.

### Example 14

A toner is obtained as in Example 1 except that, in the production of toner (1), the amount of the oil-treated silica particles is changed from 1.5 parts to 5.4 parts.

### Example 15

A toner is obtained as in Example 1 except that, in the production of toner (1), the oil-treated silica particles (5) (1.5 parts) are used.

### Example 16

A toner is obtained as in Example 1 except that, in the production of toner (1), the oil-treated silica particles (6) (1.5 parts) are used.

### Example 17

Toner particles and a toner are obtained as in Example 1 except that, in the production of toner (1), the oil-treated silica particles (2) (1.5 parts) are used.

### Example 18

A toner is obtained as in Example 1 except that, in the production of toner (1), the obtained oil-treated silica particles (7) (1.5 parts) are used.

### Example 19

A toner is obtained as in Example 1 except that, in the production of toner (1), the oil-treated silica particles (8) (1.5 parts) are used.

### Example 20

A toner is obtained as in Example 1 except that, in the production of toner (1), the oil-treated silica particles (3) (1.5 parts) are used.

### Example 21

A toner is obtained as in Example 1 except that, in the production of toner (1), the oil-treated silica particles (4) (1.5 parts) are used.

### Example 22

A toner is obtained as in Example 1 except that, in the production of toner (1), the oil-treated silica particles (9) (1.5 parts) are used.

### Example 23

A toner is obtained as in Example 1 except that, in the production of toner (1), the oil-treated silica particles (10) (1.5 parts) are used.

### Example 24

A toner is obtained as in Example 1 except that, in the production of toner (1), the oil-treated silica particles (11) are used.

### Example 25

Toner particles are obtained as in Example 1 except that, in the production of toner particles (1), 100 parts of the coloring agent-dispersed particles (1) and 0 parts of the coloring agent-dispersed particles (2) are used.

A toner is obtained as in Example 1 except that, in the production of toner (1), the obtained toner particles and the oil-treated silica particles (1) are used.

### Example 26

Toner particles are obtained as in Example 1 except that, in the production of the toner particles (1), the coloring agent-dispersed particles (3) are used instead of the coloring agent-dispersed particles (1).

A toner is obtained as in Example 1 except that, in the production of toner (1), the obtained toner particles and the oil-treated silica particles (1) are used.

### Comparative Example 1

A toner is obtained as in Example 1 except that, in the production of toner (1), 1.0 parts of the oil-treated silica particles (1) are added.

### Comparative Example 2

A toner is obtained as in Example 1 except that, in the production of toner (1), the oil-treated silica particles (1) are not added, and, in the production of the oil-treated silica particles (1), 1.5 parts of oil-untreated silica particles obtained by omitting the dimethylsilicone oil treatment are added.

### Comparative Example 3

Toner particles are obtained as in Example 1 except that, in the production of toner particles (1), the amount of the coloring agent-dispersed particles (1) is changed to 30 parts and the amount of the coloring agent-dispersed particles (2) is changed to 8 parts.

A toner is obtained as in Example 1 except that, in the production of toner (1), the obtained toner particles are used.

### Comparative Example 4

Toner particles are obtained as in Example 1 except that, in the production of toner particles (1), 140 parts of the coloring agent-dispersed particles (1) and 70 parts of the coloring agent-dispersed particles (2) are used.

A toner is obtained as in Example 1 except that, in the production of toner (1), the obtained toner particles are used.

### Comparative Example 5

Toner particles are obtained as below by the method disclosed in Japanese Unexamined Patent Application Publication No. 2016-224339.

A toner is obtained as in Example 1 except that, in the production of toner (1), the obtained toner particles are used.

### Preparation of Polyester Resin Particle Dispersion

### Preparation of Polyester Resin Particle Dispersion (1)

bisphenol A ethylene oxide 2.2 mol adduct: 40 parts by mol
bisphenol A propylene oxide 2.2 mol adduct: 60 parts by mol
dimethyl terephthalate: 60 parts by mol
dimethyl fumarate: 15 parts by mol
dodecenylsuccinic anhydride: 20 parts by mol
trimellitic anhydride: 5 parts by mol

Into a reactor equipped with a stirrer, a thermometer, a condenser, and a nitrogen gas inlet tube, the aforementioned monomers except for fumaric acid and trimellitic anhydride, and 0.25 parts of tin dioctanoate relative to a total of 100 parts of the aforementioned monomers are placed. The reaction is carried out at 235° C. for 6 hours under a nitrogen gas stream, then the temperature is decreased to 200° C., and then fumaric acid and trimellitic anhydride are added, followed by performing the reaction for 1 hour. The temperature is elevated to 220° C. over a period of 5 hours, and polymerization is carried out at a pressure of 10 kPa until a desired molecular weight is reached to thereby obtain a pale yellow, transparent polyester resin (1). The polyester resin (1) has a weight-average molecular weight of 35,000, a number-average molecular weight of 8,000, and a glass transition temperature of 59° C.

Next, the obtained polyester resin (1) is dispersed by using a dispersing machine which is Cavitron CD1010 (produced by Eurotec, Ltd.) modified to a high-temperature, high-pressure type. At an 80% ion exchange water-20% polyester resin composition ratio, the pH is adjusted to 8.5 with ammonia, Cavitron is run under the conditions of rotor rotation rate of 60 Hz, a pressure of 5 Kg/cm², and heating at 140° C. by a heat exchanger so as to obtain a polyester resin dispersion (solid content: 20%).

The volume-average particle size of the resin particles in this dispersion is 130 nm. To this dispersion, ion exchange water is added to adjust the solid content to 20%, and the resulting dispersion is used as a polyester resin particle dispersion (1).

### Preparation of Polyester Resin Particle Dispersion (2)

1,10-dodecanedioic acid: 50 parts by mol
1,9-nonanediol: 50 parts by mol

Into a reactor equipped with a stirrer, a thermometer, a condenser, and a nitrogen gas inlet tube, the aforementioned monomers are placed, the inside of the reactor is purged with dry nitrogen gas, and then 0.25 parts of titanium tetrabutoxide relative to 100 parts of the monomers is added. Under a nitrogen gas stream, the resulting mixture is stirred at 170° C. for 3 hours to induce the reaction, the temperature is further elevated to 210° C. over a period of 1 hour, the inside of the reactor is depressurized to 3 kPa, and the reaction is carried out at a reduced pressure for 13 hours under stirring to obtain a polyester resin (2).

The polyester resin (2) has a weight-average molecular weight of 25,000, a number-average molecular weight of 10,500, an acid value of 10.1 mgKOH/g, and a DSC melting temperature of 73.6° C.

Next, the obtained polyester resin (2) is dispersed by using a dispersing machine which is Cavitron CD1010 (produced by Eurotec, Ltd.) modified to a high-temperature, high-pressure type. At an 80% ion exchange water-20% polyester resin composition ratio, the pH is adjusted to 8.5 with ammonia, Cavitron is run under the conditions of rotor rotation rate of 60 Hz, a pressure of 5 Kg/cm², and heating at 140° C. by a heat exchanger so as to obtain a polyester resin dispersion (solid content: 20%).

The volume-average particle size of the resin particles in this dispersion is 180 nm. To this dispersion, ion exchange water is added to adjust the solid content to 20%, and the resulting dispersion is used as a polyester resin particle dispersion (2).

### Preparation of Pigment Dispersion (1)

fluorescent yellow pigment (C.I. Pigment Yellow 101 (Radglo VSF-0-01 produced by RADIANT COLOR NV, emission peak wavelength: 520 nm)): 70 parts
anionic surfactant (NEOGEN RK produced by DKS Co. Ltd.): 30 parts (solid component concentration: 20%)
ion exchange water: 200 parts

The aforementioned materials are mixed and pulverized to a volume-average particle size of 300 nm by using a continuous-type key mill (KMC-3 produced by INOUE MFG., INC.). The solid content is adjusted to 20%, and a pigment dispersion (1) is obtained as a result.

### Preparation of Pigment Dispersion (2)·

non-fluorescent green pigment (C.I. Pigment Green 36 (LIONOL GREEN 8624 produced by Toyocolor Co., Ltd., reflection peak wavelength: 510 nm)): 70 parts
anionic surfactant (NEOGEN RK produced by DKS Co. Ltd.): 30 parts (solid component concentration: 20%)
ion exchange water: 200 parts

The aforementioned materials are mixed and pulverized to a volume-average particle size of 150 nm by using a continuous-type key mill (KMC-3 produced by INOUE MFG., INC.). The solid content is adjusted to 20%, and a pigment dispersion (2) is obtained as a result.

### Preparation of Releasing Agent Dispersion

### Preparation of Releasing Agent Dispersion (1)

polyethylene wax (hydrocarbon wax: trade name “Polywax 725 (produced by Baker Petrolite)”, melting temperature: 104° C.): 270 parts
anionic surfactant (NEOGEN RK produced by DKS Co. Ltd., active component content: 60%): 13.5 parts (3.0% as the active component relative to the releasing agent)
ion exchange water: 21.6 parts

The aforementioned components are mixed, the releasing agent is dissolved with a pressure discharge-type homogenizer (produced by Gaulin Company, Gaulin homogenizer) at an inner liquid temperature of 120° C., a dispersing treatment is carried out at a dispersion pressure of 5 MPa for 120 minutes and then at 40 MPa for 360 minutes, and the resulting mixture is cooled to obtain a releasing agent dispersion (1). The volume-average particle size D50 of the particles in the releasing agent dispersion (1) is 225 nm. Subsequently, ion exchange water is added to adjust the solid component concentration to 20.0%.

### Preparation of Toner Particles

### Preparation of Toner Particles (15)

polyester resin particle dispersion (1): 300 parts
polyester resin particle dispersion (2): 50 parts
pigment dispersion (1): 20 parts
pigment dispersion (2): 20 parts
releasing agent dispersion (1): 15 parts
ion exchange water: 600 parts
anionic surfactant (DOWFAX 2A1 produced by Dow Chemical Company): 2.9 parts

Into a 3 L reactor equipped with a thermometer, a pH meter, and a stirrer, the aforementioned materials are placed, the pH is adjusted to 3.0 by adding 1.0% nitric acid at a temperature of 25° C., and then 100 parts of an aqueous aluminum sulfate solution having a concentration of 2% is added thereto while performing dispersing in a homogenizer (ULTRA-TURRAX T50 produced by IKA Japan) at 3000 rpm.

Upon completion of the addition, the rotating speed is increased to 5,000 rpm, and stirring is performed for 5 minutes.

Then a stirrer and a mantle heater are installed to the reactor, the temperature is elevated at a temperature elevation rate of 0.2° C./min up to a temperature of 40° C. and then at a temperature elevation rate of 0.05° C./min after exceeding 40° C. up to 53° C., and the particle size is measured every 10 minutes by using MULTISIZER II (aperture diameter: 50 μm, produced by Beckman Coulter Inc.). As soon as first aggregated particles are formed and the volume-average particle size of the first aggregated particles has reached 5.0 μm, the temperature is maintained, and 460 parts of the polyester resin particle dispersion (1) is added thereto over a period of 5 minutes.

After 50° C. is maintained for 30 minutes, 8 parts of a 20% solution of ethylenediaminetetraacetic acid (EDTA) is added relative to the total amount of the dispersion in the reactor, and then a 1 mol/L aqueous sodium hydroxide solution is added to the resulting mixture to control the pH of the raw material dispersion to 9.0. Subsequently, while the pH is adjusted to 9.0 every 5° C., the temperature is elevated at a temperature elevation rate of 1° C./min up to 90° C., and 90° C. is retained.

When the particle shape and the surface quality are observed with an optical microscope and a field-emission scanning electron microscope (FE-SEM), coalescence of particles is confirmed at the 6th hour, and thus the reactor is cooled with cooling water down to 30° C. over a period of 5 minutes.

The cooled slurry is passed through a nylon mesh having 15 μm openings to remove coarse powder, and the toner slurry that has passed through the mesh is filtered with an aspirator at a reduced pressure. The solid component remaining on the filter is manually crushed as finely as possible and added to ion exchange water in an amount 10 times as large as the amount of the solid component at a temperature of 30° C., and the resulting mixture is stirred and mixed for 30 minutes. Next, the resulting mixture is filtered with an aspirator at a reduced pressure, the solid component remaining on the filter is manually crushed as finely as possible and added to ion exchange water in an amount 10 times as large as the amount of the solid component at a temperature of 30° C., the resulting mixture is stirred and mixed for 30 minutes and is again filtered with an aspirator at a reduced pressure, and the electrical conductivity of the filtrate is measured. This operation is repeated and the solid component is washed until the electrical conductivity of the filtrate reaches 10 μS/cm or less.

The washed solid component is finely pulverized with a wet-dry-type particle size selector (comill) and vacuum-dried in a 35° C. oven for 36 hours to obtain toner particles.

### Evaluation

### Properties

The following properties of the toners of the respective examples are measured by the aforementioned methods.
the water absorption of the toner particles
the amount of the surfactant contained in the toner particles
the percentage at which the pigment exposed in the surfaces of the toner particles is covered with an oil (oil coverage)
percentage of area occupied by the pigment exposed in the toner particle surfaces

### Preparation of Developer

In a V blender, 8 parts of the toner of one example and 92 parts of a carrier (1) described below are mixed to obtain a developer of the example.

### Preparation of Carrier (1)

ferrite particles (average particle size: 35 μm): 100 parts
toluene: 14 parts
polymethyl methacrylate (MMA, weight-average molecular weight: 75,000): 5 parts
carbon black: 0.2 parts (VXC-72 produced by Cabot Corporation, volume resistivity: 100 Ω·cm or less)

The aforementioned materials other than the ferrite particles are dispersed using a sand mill to prepare a dispersion, and the dispersion and the ferrite particles are placed in a vacuum deaeration kneader and dried under stirring at a reduced pressure to obtain a carrier (1).

### Apparatus Used for Evaluation

The body, the developing unit, and the toner cartridge of DocuCentre Color 400 CP produced by FUJIFILM Business Innovation Corp., are cleaned by thoroughly removing previously set developers and toners.

Then the developers of the respective examples are placed in the developing devices, and the toners of the respective examples are placed in the toner cartridges.

This image forming apparatus is used as the evaluation apparatus, and the following evaluations are made.

### Fluorescent Intensity (Spectral Reflectance) Evaluation

In an chamber having an environment of a temperature of 28° C. and a humidity of 80% RH, a 5 cm×5 cm image composed solely of a toner is formed by using the evaluation apparatus in which the amount of the development toner in a single color 100% image on a sheet of OS coated paper produced by FUJIFILM Business Innovation Corp., is adjusted to 4.5 g/m².

The spectral reflectance in the visible light region at randomly selected 10 sites within the image surface is measured with X-Rite 939 (produced by X-Rite Incorporated, aperture: 4 mm), and the spectral reflectance values of the reflection peaks are averaged and calculated. Then evaluation is made under the following standard.

### Evaluation Standard

A: The spectral reflectance at the peak wavelength is 80% or more.
B: The spectral reflectance at the peak wavelength is 70% or more and less than 80%.
C: The spectral reflectance at the peak wavelength is less than 70%.

### Evaluation of Fogging in Initial Image

In a high-temperature, high-humidity (28° C., 85%) environment, the evaluation apparatus is left to stand for a day, and then an image having an area coverage of 40% is output on 100,000 sheets of A4 paper. Next, in a high-temperature, high-humidity (28° C., 85%) environment, the evaluation apparatus is left to stand for 3 days, and then an image having an area coverage of 1% is output on one sheet of A4 paper, and, for the fogging of the first output image (fogging in the background), the density is measured with an image density meter X-Rite 938 produced by X-Rite Incorporated and is evaluated according to the following evaluation standard.

### Evaluation Standard

G1: The fogging density is less than 0.2.
G2: The fogging density is 0.2 or more and less than 0.3.
G3: The fogging density is 0.3 or more and less than 0.4.
G4: The fogging density is 0.4 or more.

### Evaluation of Color Streaks

In a high-temperature, high-humidity (28° C., 85%) environment, the evaluation apparatus is left to stand for 1 day, and then an image having an area coverage of 1% is output on 100,000 sheets of A4 paper. Then the images output on 100 sheets from the output 99901st to 100,000th sheets are visually observed for the state of occurrence of color streaks, and evaluated according to the following evaluation standard.

### Evaluation Standard

G1: No color streak.
G2: The number of sheets in which color streaks have occurred ≤5
G3: The number of sheets in which color streaks have occurred ≤10
G4: The number of sheets in which color streaks have occurred >10

TABLE 1

| | | | | Pigment | | | | | |
|---|---|---|---|---|---|---|---|---|---|
| | | | | | | | | Percentage | |
| | | | | | | | | at which | |
| | | | | | | | | pigment | |
| | | | | | | | | exposed in | |
| | | | | | Non- | | | toner | |
| | | | | Fluo- | fluo- | | | particle | |
| | | Sur- | | rescent | rescent | Total | | surfaces | External |
| | Water | factant | Shape | pigment | pigment | pigment | Exposed | is covered | additive |
| | absorp- | content | factor | content | content | content | area | with oil | Type |
| | tion % | Mass % | — | Mass % | | | Area % | % | — |
| Example 1 | 0.4 | 0.5 | 0.922 | 7 | 3 | 10 | 33 | 43 | 1 |
| Example 2 | 0.4 | 0.5 | 0.93 | 2 | 5 | 7 | 24 | 52 | 1 |
| Example 3 | 0.4 | 0.5 | 0.926 | 3.5 | 0.8 | 4.3 | 20 | 87 | 1 |
| Example 4 | 0.4 | 0.5 | 0.927 | 13 | 6 | 19 | 38 | 22 | 1 |
| Example 5 | 0.4 | 0.5 | 0.928 | 16 | 3 | 19 | 42 | 22 | 1 |
| Example 6 | 0.9 | 1 | 0.919 | 7 | 3 | 10 | 25 | 48 | 1 |
| Example 7 | 0.4 | 0.5 | 0.922 | 4 | 3 | 7 | 9 | 72 | 2 |
| Example 8 | 0.4 | 0.5 | 0.918 | 5 | 3 | 8 | 13 | 55 | 3 |
| Example 9 | 0.4 | 0.5 | 0.924 | 15 | 3 | 18 | 48 | 41 | 4 |
| Example 10 | 0.4 | 0.5 | 0.925 | 15 | 3 | 18 | 54 | 28 | 1 |
| Example 11 | 0.4 | 0.5 | 0.922 | 7 | 3 | 10 | 33 | 24 | 1 |
| Example 12 | 0.4 | 0.5 | 0.922 | 7 | 3 | 10 | 33 | 27 | 1 |
| Example 13 | 0.4 | 0.5 | 0.922 | 7 | 3 | 10 | 33 | 49 | 1 |
| Example 14 | 0.4 | 0.5 | 0.922 | 7 | 3 | 10 | 33 | 51 | 1 |
| Example 15 | 0.4 | 0.5 | 0.922 | 7 | 3 | 10 | 33 | 22 | 5 |
| Example 16 | 0.4 | 0.5 | 0.922 | 7 | 3 | 10 | 33 | 28 | 6 |
| Example 17 | 0.4 | 0.5 | 0.922 | 7 | 3 | 10 | 33 | 55 | 2 |
| Example 18 | 0.4 | 0.5 | 0.922 | 7 | 3 | 10 | 33 | 61 | 7 |
| Example 19 | 0.4 | 0.5 | 0.922 | 7 | 3 | 10 | 33 | 49 | 8 |
| Example 20 | 0.4 | 0.5 | 0.922 | 7 | 3 | 10 | 33 | 45 | 3 |
| Example 21 | 0.4 | 0.5 | 0.922 | 7 | 3 | 10 | 33 | 39 | 4 |
| Example 22 | 0.4 | 0.5 | 0.922 | 7 | 3 | 10 | 33 | 32 | 9 |
| Example 23 | 0.4 | 0.5 | 0.922 | 7 | 3 | 10 | 33 | 23 | 10 |
| Example 24 | 0.4 | 0.5 | 0.922 | 7 | 3 | 10 | 33 | 69 | 11 |
| Example 25 | 0.4 | 0.5 | 0.92 | 10 | 0 | 10 | 35 | 65 | 1 |
| Example 26 | 0.4 | 0.5 | 0.916 | 7 | 3 | 10 | 32 | 47 | 1 |
| Comparative | 0.4 | 0.5 | 0.922 | 7 | 3 | 10 | 33 | 18 | 1 |
| Example 1 | | | | | | | | | |
| Comparative | 0.4 | 0.5 | 0.922 | 7 | 3 | 10 | 33 | 0 | Not treated |
| Example 2 | | | | | | | | | with oil |
| Comparative | 0.4 | 0.5 | 0.917 | 3 | 0.8 | 3.8 | 10 | 93 | 1 |
| Example 3 | | | | | | | | | |
| Comparative | 0.4 | 0.5 | 0.929 | 14 | 7 | 21 | 49 | 21 | 1 |
| Example 4 | | | | | | | | | |
| Comparative | 1.4. | 1.8 | 0.931 | 7 | 3 | 10 | 31 | 31 | 1 |
| Example 5 | | | | | | | | | |

| | External additive | | | | | | |
|---|---|---|---|---|---|---|---|
| | | | | Volume- | Evaluation | | |
| | | Silica | Per- | average | | | Fogging |
| | Oil | particle | centage | particle | Fluo- | | in |
| | treatment | content | of free | size | rescent | Color | initial |
| | — | Mass % | oil % | nm | intensity | streaks | image |
| Example 1 | Yes | 1.5 | 20 | 100 | A | G1 | G1 |
| Example 2 | | 1.5 | 20 | 100 | C | G2 | G3 |
| Example 3 | | 1.5 | 20 | 100 | B | G2 | G2 |
| Example 4 | | 1.5 | 20 | 100 | A | G3 | G2 |
| Example 5 | | 1.5 | 20 | 100 | A | G2 | G3 |
| Example 6 | | 1.5 | 20 | 100 | A | G2 | G3 |
| Example 7 | | 1.5 | 28 | 100 | A | G2 | G3 |
| Example 8 | | 1.5 | 23 | 18 | A | G2 | G2 |
| Example 9 | | 1.5 | 13 | 194 | A | G2 | G2 |
| Example 10 | | 1.5 | 20 | 100 | A | G2 | G3 |
| Example 11 | | 0.3 | 20 | 100 | A | G2 | G3 |
| Example 12 | | 0.6 | 20 | 100 | A | G2 | G2 |
| Example 13 | | 4.8 | 20 | 100 | A | G2 | G2 |
| Example 14 | | 5.4 | 20 | 100 | A | G3 | G3 |
| Example 15 | | 1.5 | 3 | 100 | A | G2 | G3 |
| Example 16 | | 1.5 | 6 | 100 | A | G2 | G2 |
| Example 17 | | 1.5 | 28 | 100 | A | G2 | G2 |
| Example 18 | | 1.5 | 37 | 100 | A | G2 | G3 |
| Example 19 | | 1.5 | 24 | 13 | A | G2 | G3 |
| Example 20 | | 1.5 | 23 | 18 | A | G2 | G2 |
| Example 21 | | 1.5 | 13 | 194 | A | G2 | G2 |
| Example 22 | | 1.5 | 16 | 212 | A | G2 | G3 |
| Example 23 | | 1.5 | 6 | 100 | A | G2 | G2 |
| Example 24 | | 1.5 | 28 | 100 | A | G2 | G2 |
| Example 25 | | 1.5 | 20 | 100 | B | G2 | G2 |
| Example 26 | | 1.5 | 20 | 100 | B | G2 | G2 |
| Comparative | | 1 | 20 | 100 | A | G3 | G3 |
| Example 1 | | | | | | | |
| Comparative | No | 1.5 | — | 100 | A | G2 | G4 |
| Example 2 | | | | | | | |
| Comparative | Yes | 1.5 | 20 | 100 | C | G2 | G4 |
| Example 3 | | | | | | | |
| Comparative | | 1.5 | 20 | 100 | A | G3 | G4 |
| Example 4 | | | | | | | |
| Comparative | | 1.5 | 20 | 100 | C | G4 | G4 |
| Example 5 | | | | | | | |

The aforementioned results indicate that, compared to the comparative examples, the examples can suppress fogging in the initial image that occurs when the image is formed in a high-temperature, high-humidity after the toner is stored for a long time.

Furthermore, the results also indicate that the examples exhibit high fluorescent intensity and can form images with less color streaks.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A toner for developing an electrostatic charge image, the toner comprising: a toner particle containing a binder resin and a pigment containing a fluorescent organic pigment, wherein an amount of the pigment contained relative to the toner particle is 4.0 mass % or more and 20.0 mass % or less, the toner particle has a water absorption of 1.0% or less, at least part of the pigment is exposed in a surface of the toner particle, and 20% or more of the pigment exposed in the surface of the toner particle is covered with an oil.

(((2)))

The toner for developing an electrostatic charge image described in (((1))), wherein the fluorescent organic pigment contains an azomethine compound having an emission peak wavelength of 500 nm or more and 550 nm or less.

(((3)))

The toner for developing an electrostatic charge image described in (((1))) or (((2))), wherein the pigment further contains a non-fluorescent organic pigment having a reflection peak wavelength of 480 nm or more and 540 nm or less.

(((4)))

The toner for developing an electrostatic charge image described in any one of (((1))) to (((3))), wherein, when the surface of the toner particle is observed, a percentage of an area occupied by the pigment exposed in the surface of the toner particle relative to a total area of the surface of the toner particle is 10 area % or more and 50 area % or less.

(((5)))

The toner for developing an electrostatic charge image described in any one of (((1))) to (((4))), wherein an amount of the fluorescent organic pigment contained relative to the toner particle is 3.0 mass % or more and 15.0 mass % or less.

(((6)))

The toner for developing an electrostatic charge image described in any one of (((1))) to (((5))), further comprising an oil-treated silica particle that has been treated with the oil and that serves as an external additive.

(((7)))

The toner for developing an electrostatic charge image described in (((6))), wherein an amount of the oil-treated silica particle contained relative to the toner particle is 0.5 mass % or more and 5.0 mass % or less.

(((8)))

The toner for developing an electrostatic charge image described in (((6))), wherein an amount of free oil in the oil-treated silica particle relative to the oil-treated silica particle is 5.0 mass % or more and 30.0 mass % or less.

(((9)))

The toner for developing an electrostatic charge image described in (((6))), wherein the oil-treated silica particle has a volume-average particle size of 15.0 nm or more and 200 nm or less.

(((10)))

The toner for developing an electrostatic charge image described in any one (((1))) to (((9))), wherein the toner particle has an average circularity of less than 0.940.

(((11)))

A method for producing the toner for developing an electrostatic charge image described in any one of (((1))) to (((10))), the method comprising: kneading the binder resin and the pigment containing the fluorescent organic pigment to obtain a kneaded material; and pulverizing the obtained kneaded material to obtain a toner particle.

(((12)))

An electrostatic charge image developer comprising the toner for developing an electrostatic charge image described in any one of (((1))) to (((10))).

(((13)))

A toner cartridge detachably attachable to an image forming apparatus, the toner cartridge comprising the toner for developing an electrostatic charge image described in any one of (((1))) to (((10))).

(((14)))

A process cartridge detachably attachable to an image forming apparatus, the process cartridge comprising a developing device that stores the electrostatic charge image developer described in (((12))) and that develops an electrostatic charge image on a surface of an image bearing member into a toner image by using the electrostatic charge image developer.

(((15)))

An image forming apparatus comprising: an image bearing member; a charging device that charges a surface of the image bearing member; an electrostatic charge image forming device that forms an electrostatic charge image on the charged surface of the image bearing member; a developing device that stores the electrostatic charge image developer described in (((12))) and that develops the electrostatic charge image on the surface of the image bearing member into a toner image by using the electrostatic charge image developer; a transfer device that transfers the toner image on the surface of the image bearing member onto a surface of a recording medium; and a fixing device that fixes the toner image transferred onto the surface of the recording medium.

What is claimed is:

1. A toner for developing an electrostatic charge image, the toner comprising:
a toner particle containing:
a binder resin; and
a pigment containing a fluorescent organic pigment,
wherein an amount of the pigment contained relative to the toner particle is 4.0 mass % or more and 20.0 mass % or less,
the toner particle has a water absorption of 1.0% or less,
at least part of the pigment is exposed in a surface of the toner particle, and
20% or more of the pigment exposed in the surface of the toner particle is covered with an oil.

2. The toner for developing an electrostatic charge image according to claim 1, wherein the fluorescent organic pigment contains an azomethine compound having an emission peak wavelength of 500 nm or more and 550 nm or less.

3. The toner for developing an electrostatic charge image according to claim 2, wherein the pigment further contains a non-fluorescent organic pigment having a reflection peak wavelength of 480 nm or more and 540 nm or less.

4. The toner for developing an electrostatic charge image according to claim 1, wherein, when the surface of the toner particle is observed, a percentage of an area occupied by the pigment exposed in the surface of the toner particle relative to a total area of the surface of the toner particle is 10 area % or more and 50 area % or less.

5. The toner for developing an electrostatic charge image according to claim 1, wherein an amount of the fluorescent organic pigment contained relative to the toner particle is 3.0 mass % or more and 15.0 mass % or less.

6. The toner for developing an electrostatic charge image according to claim 1, further comprising an oil-treated silica particle that has been treated with the oil and that serves as an external additive.

7. The toner for developing an electrostatic charge image according to claim 6, wherein an amount of the oil-treated silica particle contained relative to the toner particle is 0.5 mass % or more and 5.0 mass % or less.

8. The toner for developing an electrostatic charge image according to claim 6, wherein an amount of free oil in the oil-treated silica particle relative to the oil-treated silica particle is 5.0 mass % or more and 30.0 mass % or less.

9. The toner for developing an electrostatic charge image according to claim 6, wherein the oil-treated silica particle has a volume-average particle size of 15.0 nm or more and 200 nm or less.

10. The toner for developing an electrostatic charge image according to claim 1, wherein the toner particle has an average circularity of less than 0.940.

11. A method for producing the toner for developing an electrostatic charge image according to claim 1, the method comprising:
kneading the binder resin and the pigment containing the fluorescent organic pigment to obtain a kneaded material; and
pulverizing the obtained kneaded material to obtain a toner particle.

12. A method for producing the toner for developing an electrostatic charge image according to claim 2, the method comprising:
kneading the binder resin and the pigment containing the fluorescent organic pigment to obtain a kneaded material; and
pulverizing the obtained kneaded material to obtain a toner particle.

13. A method for producing the toner for developing an electrostatic charge image according to claim 3, the method comprising:
kneading the binder resin and the pigment containing the fluorescent organic pigment to obtain a kneaded material; and
pulverizing the obtained kneaded material to obtain a toner particle.

14. A method for producing the toner for developing an electrostatic charge image according to claim 4, the method comprising:
kneading the binder resin and the pigment containing the fluorescent organic pigment to obtain a kneaded material; and
pulverizing the obtained kneaded material to obtain a toner particle.

15. A method for producing the toner for developing an electrostatic charge image according to claim 5, the method comprising:
kneading the binder resin and the pigment containing the fluorescent organic pigment to obtain a kneaded material; and
pulverizing the obtained kneaded material to obtain a toner particle.

16. A method for producing the toner for developing an electrostatic charge image according to claim 6, the method comprising:
kneading the binder resin and the pigment containing the fluorescent organic pigment to obtain a kneaded material; and
pulverizing the obtained kneaded material to obtain a toner particle.

17. An electrostatic charge image developer comprising the toner for developing an electrostatic charge image according to claim 1.

18. A toner cartridge detachably attachable to an image forming apparatus, the toner cartridge comprising the toner for developing an electrostatic charge image according to claim 1.

19. A process cartridge detachably attachable to an image forming apparatus, the process cartridge comprising a developing device that stores the electrostatic charge image developer according to claim 17 and that develops an electrostatic charge image on a surface of an image bearing member into a toner image by using the electrostatic charge image developer.

20. An image forming apparatus comprising:
an image bearing member;
a charging device that charges a surface of the image bearing member;
an electrostatic charge image forming device that forms an electrostatic charge image on the charged surface of the image bearing member;
a developing device that stores the electrostatic charge image developer according to claim 17 and that develops the electrostatic charge image on the surface of the image bearing member into a toner image by using the electrostatic charge image developer;
a transfer device that transfers the toner image on the surface of the image bearing member onto a surface of a recording medium; and
a fixing device that fixes the toner image transferred onto the surface of the recording medium.
